(19) United States
(12) Patent Application Publication
(10) Pub. No.: US 2016/0131767 A1
(43) Pub. Date: May 12, 2016

(54) NONLINEAR PROCESSING FOR OFF-AXIS FREQUENCY REDUCTION IN DEMODULATION OF TWO DIMENSIONAL FRINGE PATTERNS

(71) Applicant: CANON KABUSHIKI KAISHA, Tokyo (JP)

(72) Inventors: PETER ALLEINE FLETCHER, Rozelle (AU); ANDREW DOCHERTY, St Leonards (AU); KIERAN GERARD LARKIN, Putney (AU)

(21) Appl. No.: 14/931,676

(22) Filed: Nov. 3, 2015

(30) Foreign Application Priority Data
Nov. 6, 2014 (AU) 2014259516

(51) Int. Cl. G01T 1/00; G01T 7/00

(52) U.S. Cl. CPC G01T 1/00; G01T 7/00

(57) ABSTRACT

A method of demodulating an image captured from an imaging system having at least one two-dimensional grating. The captured image comprises a phase modulated fringe pattern comprising cross-term phase components resulting from presence of the at least one two-dimensional grating. The method determines parameters of at least a first non-linear transformation for attenuating the cross-term phase components. The parameters of the first non-linear transformation are determined for the imaging system to reduce artefacts in a demodulated image introduced by the cross-term phase components. The method demodulates the captured image by applying at least the first non-linear transformation with the determined parameters to the captured image to attenuate the cross-term phase components.

### REFERENCE TO RELATED PATENT APPLICATION(S)

This application claims the benefit under 35 U.S.C. §119 of the filing date of Australian Patent Application No. 2014259516, filed Nov. 6, 2014, hereby incorporated by reference in its entirety as if fully set forth herein.

### TECHNICAL FIELD

The present invention relates generally to the field of spatial demodulation for fringe analysis, where two or more fringe frequencies or orientations are used within an image. In particular, described are methods to assist with the demodulation of two-dimensional sets of fringes associated with an X-ray moiré device, and in which undesirable off-axis frequencies appear in conjunction with the desirable frequencies containing signal content.

### BACKGROUND

Currently there are two main approaches to the demodulation of X-ray Talbot moiré interferograms. The first approach is by (temporal) phase-shifting algorithms (also known as multi-shot algorithms). The second approach is by one-shot demodulation algorithms. This description considers demodulation from single (one-shot) fringe patterns produced by an X-ray Talbot interferometer of the type schematically shown in FIG. 1. The fringe patterns are generated by two-dimensional (2D) crossed-gratings, resulting in a mesh-like pattern exhibiting an intricate harmonic structure. FIG. 2A shows an example of a synthesised pattern 210 (in this case derived from imaging a bone joint), and FIG. 2B shows a corresponding Fourier transform 220. The Fourier transform 220 illustrates a nine-sidelobe harmonic structure.

The field of fringe analysis is concerned with the demodulation of one or more images of fringe patterns, where each image includes a summation of at least one sinusoidal fringes, with each fringe having a different phase in each image. Such images take the form:

$$I ( r ) = A ( r ) {\sum }_{j = 1}^{k} {m}_{j} ( r ) cos ( {ω}_{j} \cdot r + {Φ}_{j} ( r ) ) + {S}_{i} ( r ) , \qquad [ 1 ]$$

where Iᵢ is a captured two-dimensional image indexed by the coordinate vector r=(x,y) containing intensity values obtained from a summation of sinusoidal fringes, with i representing an image number, 1≦i≦n, Sᵢ represents a non-sinusoidal noise image, A represents a positive intensity image, and j represents a fringe number, 1≦j≦k. Each fringe is represented by a usually-positive modulation amplitude image mⱼ, a phase image Φᵢ, and a real number φᵢⱼ, being a phase offset for a fringe j in the image i.

The images Iᵢ can be assumed to be two-dimensional for explanatory purposes, but there is no reason to limit the dimensionality, and this specification is applicable for two or more dimensions.

The fringes can be created through a variety of means, such as projected sinusoids, imaged test patterns, interference patterns of coherent sources, or moiré patterns. The images can be composed of visible light, X-rays, audio waves or any other source of information that can be imaged in two or more dimensions.

The demodulation process is the recovery, from the set of images Iᵢ, of the amplitude A, the modulation amplitudes mⱼ and the phases ωⱼ. The amplitude image has units representing the intensity of the illumination, where ωⱼ is usually a positive, real, unitless amplitude function, with value smaller than 1.0, and ωᵢ is the phase of a complex value (mⱼ can in some circumstances be negative). The function ωᵢ can usually be determined as only the fractional part of the total number of wavelengths, i.e. modulo 2π radians, and a phase unwrapping algorithm is used to reconstruct the total phase, which has excursions beyond this range, as a continuous function.

Using a phase-stepping algorithm it is possible to calculate these quantities directly by capturing multiple images in which the fringes contain different phase offsets φᵢⱼ and by using various techniques to, firstly, separate the k different fringe patterns from each other, and, secondly, to demodulate the real-valued fringe patterns to obtain the amplitude image mⱼ and phase image ωⱼ for all k fringes and for the two-dimentional coordinate values that are present in all images.

Capturing the required number of images to separate and demodulate the fringes can, in some applications, require excessive processing time and therefore not practicable. Furthermore, capturing many images can make the imaging system more sensitive to problems, such as subject motion. Thus it is desirable to perform demodulation using a smaller number of images, or even a single image. In these cases it is possible to take only a single image, or fewer than is required to directly separate the fringes, and use alternative means to extract the amplitude and phase images.

In the cases where the phase steps are not known at the time an image is taken, or the specific frequencies of the fringes are not known, those parameters can be measured by analyzing the images using the Fourier Transform, or by other techniques. Assuming that the fringe patterns are properly band-limited, i.e. the image of each fringe pattern in the Fourier transform is localized to non-overlapping regions of the Fourier transform, the fringe patterns can be separated by any of a number of techniques which isolates the fringes based upon their frequencies. However, there are several effects which can cause ambiguity in the solution and limit the effectiveness of such methods:

Firstly, a signal is generally modulated onto a carrier frequency by amplitude and phase modulation. This modulation causes a spreading of the signal in the Fourier domain, and it is usually not possible to limit the bandwidth of the resulting fringe pattern. If the bandwidth of a signal is larger than the spacing between that signal and neighbouring signals in the Fourier domain, the signal will overlap with the other, neighbouring, signals. When two signals overlap in the spatial domain and the Fourier domain, only their sum is detectable and it is usually not possible to separate fringes using Fourier or spatial techniques without knowledge of further constraints related to the signal generation process.

Secondly, the signal generation process itself might lead to the creation of more frequencies than is desirable. For example, where an imaging system generates fringes by a moiré pattern resulting from the combination of two crossed gratings, the spectrum of the resulting image matches that of the spectrum of the grating, which can be significantly broader than an ideal sinusoidal fringe.

Thirdly, where a modulating frequency does not produce an exact number of wavelengths across the area of the imaging sensor, the corresponding Fourier transform produces a sinc function which drops relatively slowly away from the centre (carrier) frequency, and hence covers the full spectrum to some extent.

Fourthly, a real cosine function produces two images (called a “Hermitian pair”) in the Fourier domain, symmetrical about the origin and with Hermitian symmetry. However, again, if the bandwidth of the phase function is too large, then the two Hermitian pairs will overlap, resulting in further ambiguity.

The combination of all of these effects can result in different signals overlapping in the Fourier domain, which is cross-talk. A failure to properly separate these overlapping signals results in signals becoming intermixed during demodulation, which results in distortion.

Naïve demodulation methods separate different signals in the frequency spectrum by a combination of filtering in the spectral domain and in the spatial domain, and demodulation of a carrier frequency by multiplication with a complex frequency in the spatial domain or equivalently the shifting of a window in the spectral domain from the carrier frequency to the origin.

However, these methods cannot account for overlapping signals, and thus do not remove the distortion due to cross-talk.

### SUMMARY

Presently disclosed are methods directed towards using a nonlinear function on a fringe image to suppress off-axis terms, in order to allow on-axis fringes to be separated. Another nonlinear function can be used to remove the harmonics which result from the first nonlinear function.

According to one aspect of the present disclosure, there is provided a method of demodulating an image captured from an imaging system having at least one two-dimensional grating, the captured image comprising a phase modulated fringe pattern comprising cross-term phase components resulting from presence of the at least one two-dimensional grating, the method comprising:

determining parameters of at least a first non-linear transformation for attenuating the cross-term phase components, wherein the parameters of the first non-linear transformation are determined for the imaging system to reduce artefacts in a demodulated image introduced by the cross-term phase components; and

demodulating the captured image by applying at least the first non-linear transformation with the determined parameters to the captured image to attenuate the cross-term phase components.

Desirably the determining of parameters of the first non-linear transformation comprises:

determining a ratio between a magnitude of the cross-term and a magnitude of on-axis phase components for a calibration image captured using the imaging system; and

determining parameters of the non-linear transformations using the determined ratio.

The determining of parameters may further comprise:

establishing a parameterised non-linear transformation to reduce impact of the cross-term phase components for further demodulation;

receiving a plurality of reference images captured with the imaging system of a phase modulated fringe pattern comprising cross-term phase components;

first demodulating the reference images using a multi-shot demodulation method to produce a reference demodulated image;

identifying initial parameters for the established parameterised non-linear transformation to form an initial non-linear transformation;

forming a candidate demodulated image by second demodulating one of the reference images using a single-shot demodulation method applied to the reference image transformed in accordance with the initial non-linear transformation; and

comparing the candidate demodulated image with the reference demodulated image to adjust parameters of the non-linear transformation.

In a specific implementation, the method repeats the second demodulating with the adjusted parameters to form a revised candidate demodulated image to reduce an error between the candidate demodulated image and the reference demodulated image. Preferably the second demodulating is repeated until the error falls below a predetermined limit.

Desirably, the adjusted parameters are utilised to reduce impact of cross-term phase components in demodulation of further images captured by the imaging system.

Advantageously, the demodulating of the captured image further comprises:

applying the first non-linear transformation to the captured image to produce a first image with attenuated the cross-term phase components; and

producing an x-phase image and a y-phase image by filtering from the first image, in Fourier domain, y and x terms of the first image respectively.

Preferably, this may further comprise:

establishing a second non-linear transformation configured for attenuating harmonics introduced by application of the first non-linear transformation to the captured image, wherein the second non-linear transformation is established by inverting the first non-linear transformation; and

applying the second non-linear transformation to each of the x-phase image and the y-phase image to attenuate harmonics introduced by operation of the first non-linear transform.

In another implementation, the filtering comprises:

transforming the first image into the Fourier domain;

applying at least one mask to the transformed first image; and

transforming the masked image into the spatial domain.

Desirably the applying comprises multiplying the transformed first image by a first mask to produce the x-phase image and by a second mask to produce the y-phase image. Preferably the at least one mask is adapted to remove predetermined frequency spectra from the image.

The method may further comprise subtracting a low frequency spectrum from the phase images to for separated fringe patterns.

Preferably the first non-linear transformation comprises an offset-logarithmic function. Advantageously the second non-linear transformation comprises an exponential transform.

Alternatively the first and second non-linear transformations comprise respective power functions.

Typically the imaging system comprises an X-ray interferometer system.

Other aspects are also disclosed.

### BRIEF DESCRIPTION OF THE DRAWINGS

At least one embodiment of the present invention will now be described with reference to the following drawings, in which:

FIG. 1 is a diagram of the experiment set-up for an X-ray Talbot interferometer;

FIGS. 2A and 2B show an illustrative example of a Talbot moiré image and its Fourier transform;

FIG. 3 is a schematic flow diagram of an image capture and demodulation process;

FIG. 4 is a schematic flow diagram illustrating a method of reducing off-axis terms during demodulation using a nonlinear function;

FIG. 5 is a schematic flow diagram illustrating a method of applying a nonlinear transform to the pixels in an image;

FIG. 6 is a schematic flow diagram illustrating a method of reducing both off-axis terms and harmonics while producing separated fringe patterns from a captured image;

FIGS. 7A to 7F illustrate the position of Fourier spectra involved in the processing described in FIG. 6;

FIGS. 8A and 8B illustrate the separation masks involved in the processing described in FIG. 6;

FIG. 9 is a schematic flow diagram illustrating a method of demodulating a separated fringe pattern;

FIG. 10 is a schematic flow diagram illustrating a method of estimating parameters for nonlinear functions used during the demodulation process;

FIG. 11 is a schematic flow diagram illustrating a method of identifying optimal parameters for nonlinear functions used during the demodulation process;

FIGS. 12A to 12H illustrate the spectral masks involved in the processing described in FIG. 9;

FIG. 13 is a schematic flow diagram illustrating a method of estimating parameters for nonlinear functions used during the demodulation process;

FIG. 14 is a schematic flow diagram illustrating a method of demodulating a Talbot moiré image using the log-offset transform;

FIG. 15 is a schematic flow diagram illustrating a method of demodulating a Talbot moiré image using a parameterized power function;

FIG. 16 is a schematic flow diagram illustrating a method for estimating the absorption image involved in the processing described in FIG. 14;

FIG. 17 is a schematic flow diagram illustrating a method for demodulation by first separating a fringe pattern into on-axis fringes and then demodulating each pattern individually; and

FIGS. 18A and 18B collectively form a schematic block diagram of a general purpose computer system upon which arrangements described can be practiced.

### DETAILED DESCRIPTION INCLUDING BEST MODE

### Context

The present disclosure relates to the demodulation of fringe patterns containing two or more groups of fringes, provided as one or more images. In the situation that the number of images captured is not sufficient to properly separate distinct fringe patterns, and where the frequency bands of the fringe patterns overlap, the demodulation problem becomes ambiguous. Therefore, the demodulated images can become distorted by cross-talk.

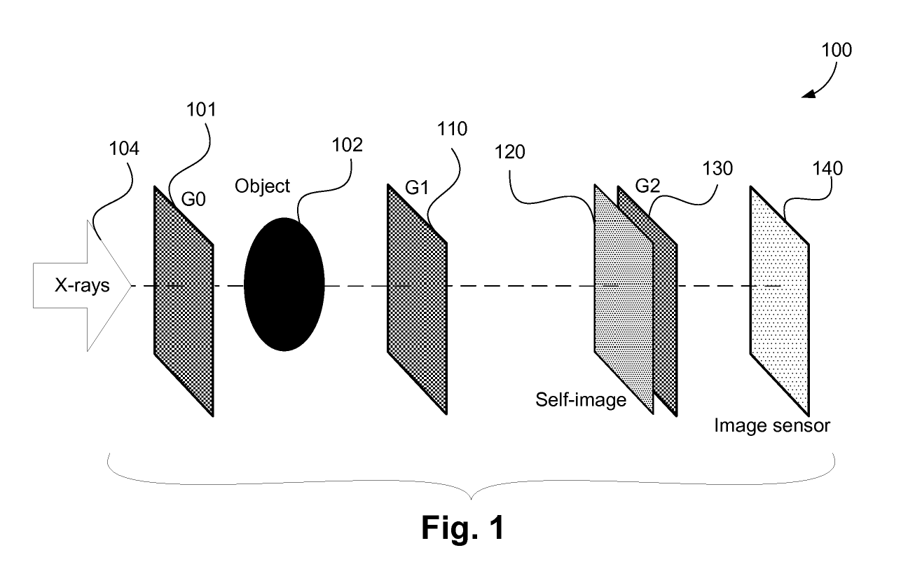

Many imaging systems can produce fringe images. One example is a two-dimensional X-ray Talbot (XT) image system. FIG. 1 shows a schematic representation of an example of an X-ray Talbot interferometer 100, in which a two-dimensional source grating G0 101, an object 102 and a two-dimensional phase grating G1 110 are illuminated by an X-ray imaging source 104. A self-image 120 is formed behind the phase grating G1 110 due to the Talbot effect. Since the phase of the X-ray wave is shifted by the object 102, the self-image is deformed. By analysing the deformed self-image, the characteristics of the object 102 can be deduced. Because this type of X-ray imaging uses phase differences instead of absorption, to produce contrast, the resolution of an XT system is much higher than conventional absorption X-ray. In FIG. 1, a second two-dimensional absorption grating G2 130 at the position of the self-image generates a clear moiré fringe pattern. Normally the period of the second absorption grating G2 130 is designed to be similar to that of the self-image, so the moiré pattern generated by superposing the deformed self-image and second absorption grating G2 130 gives a much larger version of the original self-image in order for an image sensor 140 to resolve and capture the moiré pattern. According to the single-shot approach, processing is performed upon a single image captured by the image sensor 140. In a multi-shot approach, phase changes are imposed into the gratings 101, 110 and 130 (e.g. shift and/or rotation) and an image captured for each change.

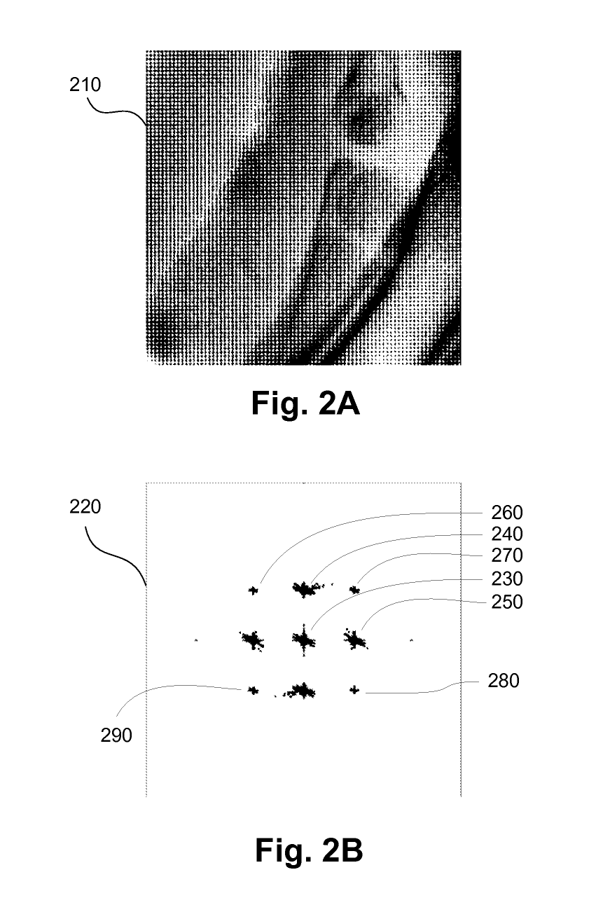

FIG. 2A shows an example image 210 derived from an X-ray Talbot interferometer. The image 210 is a moiré image taken from an image sensor resulting from imaging an animal, with animal bones visible to the right of the image 210, animal fur discernible to the left of the image 210, and a pattern of dots visible across the image and being a moiré pattern containing encoded amplitude and phase information.

Neglecting the complications of the Talbot effect, this pattern of dots in FIG. 2A can be interpreted as if it were composed of the product of the grid patterns produced by the G1 grating 110 and the G2 grating 130, which is a high-frequency pattern, shifted by the moiré effect to frequencies low enough so as to be visible to a conventional X-ray imaging sensor.

The normal spectra of a grid-like grating is itself a grid, but due to filtering effects around each grid element, the moiré spectrum is substantially composed of only the DC component and the fundamental, with subsequent harmonics being of very low amplitude.

Thus, the moiré image is substantially composed of the summation of four phase- and amplitude-modulated cosine intensity functions, with one varying along the x axis, one varying along the y axis, and one each varying along the line (x+y) and (x−y) respectively, i.e. varying at angles of 0°, 90°, 45° and 135° respectively. Each of these cosine functions is attenuated by an absorption function.

FIG. 2B shows the Fourier Transform 220 of the image 210, in which the strongest spectral components, such as 230, 240, 250, 260, 270, of the moiré pattern are clearly visible. In FIG. 2B, the spectrum 220 has nine components of which the components labelled include a DC component 230, an x component 240, a y component 250, an (x+y) cross-component 270, an (x−y) cross-component 260, a (y−x) cross-component 280, and a −(x+y) cross-component 290. In FIG. 2B the components 240 and 250 are examples of on-axis terms, and the components 260-290 are examples of off-axis terms.

The Fourier Transform is a change of basis which expresses a function or vector as the integration, or sum, of complex exponentials. The fringe patterns are constructed from the summation of real, as opposed to complex, functions, but each fringe pattern can also be expressed as the sum of two complex exponentials, thus (where i=\sqrt{−1}):

$$cos ( x ) = \frac{{e}^{i x} + {e}^{- i x}}{2}$$

The Fourier transform is easily extended to more than one dimension simply by computing the transform over any other dimensions separably, i.e. the Fourier transform of a 2D image is simply the Fourier transform of the columns of the Fourier transform of the rows.

If a real 2D fringe pattern is transformed to the Fourier domain, it can be expressed as the summation of two complex exponentials and will thus appear as two lobes, with Hermitian symmetry. If the two lobes do not overlap, then the frequencies representing either one of the complex exponentials can be extracted by zeroing the other lobe, and the inverse Fourier transform of this extracted lobe will give the fringe demodulated in quadrature with the phase extracted by means of a complex logarithm.

If the phase ω of the fringes is substantially a linear function and the amplitude is approximately constant, with w being the width of the image, h being the height of the image, and u, v being the number of wavelengths in the x, y directions respectively, then it is possible to define the two-dimensional (2D) frequency of the fringes as:

$$( {f}_{x} , {f}_{y} ) = ( \frac{u}{w} , \frac{v}{h} ) , \\ and$$

$$ω \cdot r + {ϕ}_{0} \approx 2 π ( {f}_{x} x + {f}_{y} y ) + {ϕ}_{0} ,$$

From the above, it will be appreciated that the phase function φ is linear and therefore close to a single frequency. The above function can be approximately expressed:

$$cos ( ω \cdot r + {ϕ}_{0} ) = \frac{{e}^{i ( ω \cdot r + {ϕ}_{0} )} + {e}^{- i ( ω \cdot r + {ϕ}_{0} )}}{2} \approx \frac{{e}^{2 π i ( {f}_{x} x + {f}_{y} y ) + {ϕ}_{0}} + {e}^{- 2 πi ( {f}_{x} x + {f}_{y} y ) + {ϕ}_{0}}}{2}$$

If each fringe frequency in the set of fringes is constant, a Fourier transform of the sum of the fringes will contain two delta functions at each position (u,v) and (−u,−v), with a phase of φ₀ and −φ₀ respectively.

By measuring the position of each peak of the Fourier transform, the carrier frequency of each fringe pattern can be estimated, and by measuring the phase of each peak, the phase offset of each fringe pattern can be estimated. By comparing the ratio of the amplitude of each peak to the amplitude of the DC position of the Fourier transform, then m can be estimated, i.e. m≈|a|/|A|.

Returning to FIG. 2B, a region 230 at the centre of the Fourier transform 220 is the absorption spectrum, whereas the spectral component 240 shows the spectrum containing fringes in the y direction encoding the x phase derivative, the spectral component 250 shows the spectrum containing fringes in the x direction encoding the y phase derivative, the spectral component 260 contains undesired off-axis terms containing the differences of the x and y phase derivatives, and spectral component 270 contains undesired off-axis terms containing the sums of the x and y phase derivatives.

The axis along which the phase derivative is measured, and the axis along which fringes encoding this derivative vary, may be independently varied by changing the positions of the gratings in the interferometer system 100. The orientation of the gratings as shown is chosen to keep both positive and negative derivatives symmetrical with respect to the spectral properties of the system 100.

The unlabelled spectral components in FIG. 2B are the Hermitian pairs of the labelled spectral components, and appear because the moiré image is real. Note that FIG. 2B is for illustrative purposes only, and the overlap of the spectral components has not been shown for purposes of clarity. If substantial cross-talk were occurring, then the spectral content around each carrier frequency would appear broader, and the black regions in FIG. 2B would overlap.

It should also be noted that the terms “on-axis” and “off-axis” refer respectively to the axes of the gratings 101, 110, 130, not the sensor 140, and hence the image generation process does not actually require that the “on-axis” terms appear on the u and v axes of the Fourier transform. If these terms are not aligned to the u and v axis, then their position can be found by finding two spectral peaks in the Fourier transform of a calibration moiré image containing no object in the presence of undesirable terms at a position corresponding to the sum and difference of these detected frequencies. However, for simplicity, it will henceforth be assumed that this is so.

The spectrum of the image can be described as a special case of the fringe model described earlier, and takes the form:

$$I = {S}_{i} + A [ 1 + {m}_{x} cos ( {ω}_{x} x + {Φ}_{x} ( r ) ) + {m}_{y} cos ( {ω}_{y} y + {Φ}_{y} ( r ) ) + {m}_{u} cos ( {ω}_{x} x + {ω}_{y} y + {Φ}_{x} ( r ) + {Φ}_{y} ( r ) ) + {m}_{v} cos ( {ω}_{x} x - {ω}_{y} y + {Φ}_{x} ( r ) - {Φ}_{y} ( r ) ) ] , \qquad [ 2 ]$$

where Sᵢ is the 2D noise signal, A is the 2D absorption image of the object, mₓ and m_{y} are 2D images containing the amplitude modulation of the on-axis carriers, mᵤ and mᵥ are 2D images containing the amplitude modulation of the off-axis carriers, ωₓ and ω_{y} the frequencies of the on-axis carriers, and Φₓ and Φ_{y} are the phase images. Each Φ contains a single arbitrary phase offset which defines the phase at the origin, and a phase modulation function representing the derivative of the optical path length. The optical path length varies where the X-rays intersect an object, as different materials have different refractive indices.

A major source of corruption in the single-shot method is spectral overlap, or crosstalk, between cross-terms of the gradients. This is a problem with high-bandwidth signals and can be seen in the Fourier space image 220 where the off-axis (diagonally modulated) signals 260 and 270 overlap the x and y modulated signals. These off-axis signals are not desired, because they will cause distortion of the on-axis signals due to cross-talk, and do not provide any extra phase information beyond that in the on-axis signals 240 and 250. The amplitude of the off-axis signals is as a result of the spectrum of the cells in the grating elements. If the off-axis signals were to correspond to a direct product of the on-axis fringes, then homomorphic processing using a logarithmic function can remove these off-axis fringes. This has the effect of reducing cross-term artefacts, increasing both bandwidth and quality.

The main objective of homomorphic processing is to separate multiplicative processes into additive processes, apply linear filtering, and then transform the processed image back to the original domain. The linear filtering is typically performed in the Fourier transform domain.

Assuming a multiplicative model of the 2D intensity moiré pattern, modelled as the product of three components: the X-ray absorption factor A, the x-direction fringe term, and the y-direction fringe term, the spectral image resolves into a specific form of Equation 2, being:

I(r)=A(r){1+mₓ(r)cos [ωₓx+Φₓ(r)]}×{1+m_{y}(r)cos [ω_{y}y+Φ_{y}(r)]}. [3]

Next the signal or image intensity of Equation 2 is logarithmically mapped, to get the following:

$$log I ( r ) = log A ( r ) + log \{ 1 + {m}_{x} ( r ) cos [ {ω}_{x} x + {Φ}_{x} ( r ) ] \} + log \{ 1 + {m}_{y} ( r ) cos [ {ω}_{y} y + {Φ}_{y} ( r ) ] \} . \qquad [ 4 ]$$

The original product of the three components has now been converted to an addition of the three components. Because there is no longer a product of the x and y fringe terms, the off-axis cross-terms are now removed and are not observable in the Fourier domain. With the removal of the off-axis cross-terms, the x and y fringe patterns are cleanly separated in the Fourier domain and can be isolated by a simple spectral filter.

After filtering, the two images can be transformed back to the spatial domain and analysed separately. It is an important point, and one that is considered later in this document, that the harmonics generated in the carrier frequencies by the logarithm can be exactly removed by calculating the inverse logarithm, namely the exponential, of the resulting filtered image in the spatial domain. If there is no overlap in the Fourier domain of the original carrier frequencies, this process will successfully reconstruct the fringes for the x and y carriers separately.

After the harmonics have been removed by exponentiation, it is possible to separate the modulation and phase terms by calculating the corresponding analytic signal. The analytic signal of a real cosine function is a complex exponential and from this it is possible to calculate the magnitude and the phase term of this complex signal, to give estimates of the modulation terms, mₓ and m_{y}, and the phase terms, Φₓ and Φ_{y}, of the x and y fringe patterns respectively.

Unfortunately, the product model does not match the physical properties of the X-ray Talbot system and is not effective when dealing with real data.

Physical Implementation

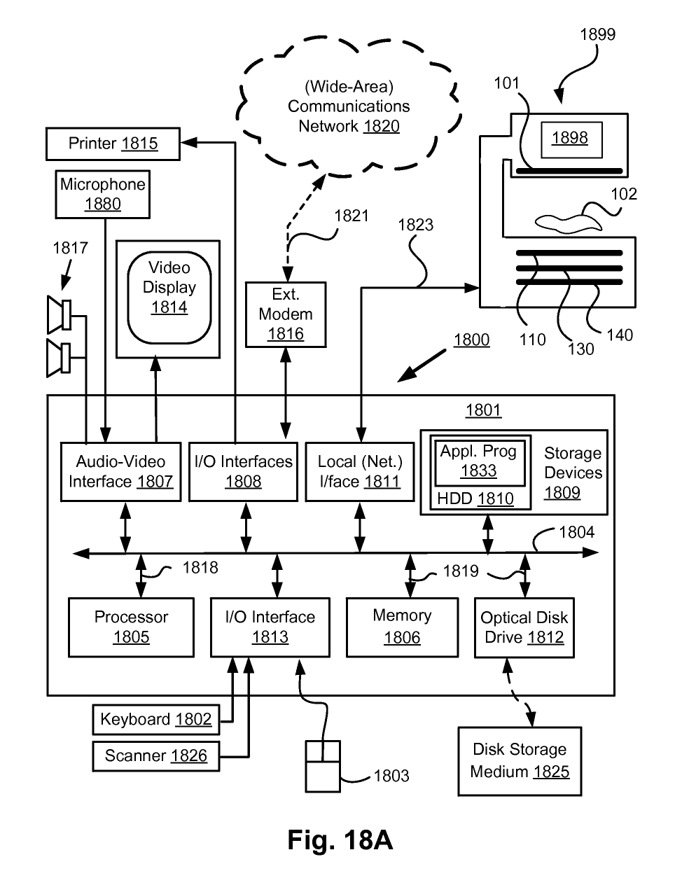

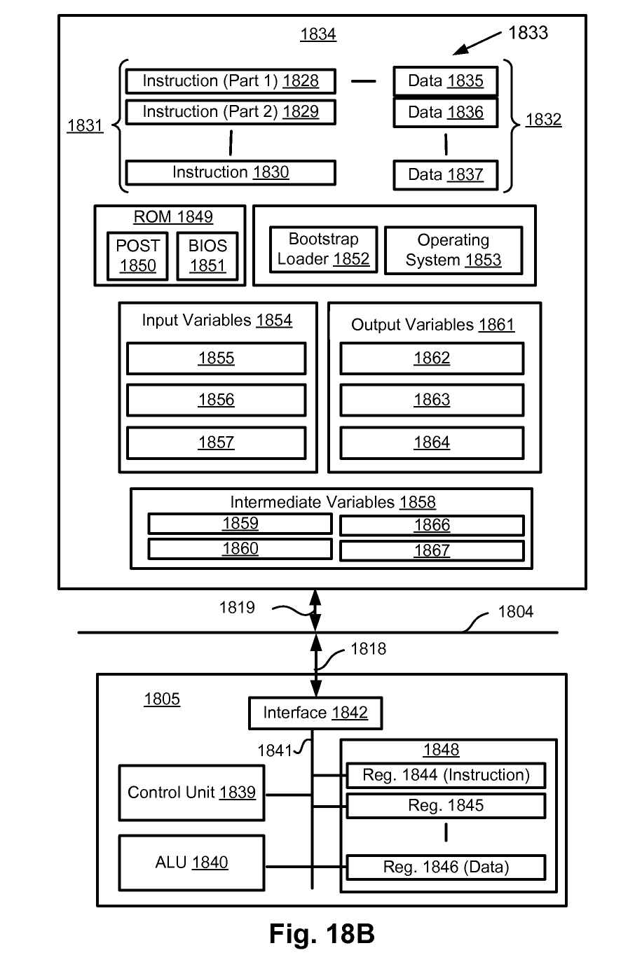

FIGS. 18A and 18B depict a general-purpose computer system 1800, upon which the various arrangements described can be practiced.

As seen in FIG. 18A, the computer system 1800 includes: a computer module 1801; input devices such as a keyboard 1802, a mouse pointer device 1803, a scanner 1826, a camera 1827, and a microphone 1880; and output devices including a printer 1815, a display device 1814 and loudspeakers 1817. An external Modulator-Demodulator (Modem) transceiver device 1816 may be used by the computer module 1801 for communicating to and from a communications network 1820 via a connection 1821. The communications network 1820 may be a wide-area network (WAN), such as the Internet, a cellular telecommunications network, or a private WAN. Where the connection 1821 is a telephone line, the modem 1816 may be a traditional “dial-up” modem. Alternatively, where the connection 1821 is a high capacity (e.g., cable) connection, the modem 1816 may be a broadband modem. A wireless modem may also be used for wireless connection to the communications network 1820.

The computer module 1801 typically includes at least one processor unit 1805, and a memory unit 1806. For example, the memory unit 1806 may have semiconductor random access memory (RAM) and semiconductor read only memory (ROM). The computer module 1801 also includes an number of input/output (I/O) interfaces including: an audio-video interface 1807 that couples to the video display 1814, loudspeakers 1817 and microphone 1880; an I/O interface 1813 that couples to the keyboard 1802, mouse 1803, scanner 1826, and optionally a joystick or other human interface device (not illustrated); and an interface 1808 for the external modem 1816 and printer 1815. In some implementations, the modem 1816 may be incorporated within the computer module 1801, for example within the interface 1808. The computer module 1801 also has a local interface 1811, which permits coupling of the computer system 1800 via a connection 1823 to an X-ray Talbot imaging apparatus 1899, implementing an imaging arrangement akin to that shown in FIG. 1. The interface 1811 is used by the computer module 1801 to receive image data captured by the image sensor 140 representative of the object 102 being imaged, such as a biological sample. The interface 1811 may be a network interface including for example Ethernet circuit card, a Bluetooth™ wireless arrangement or an IEEE 802.11 wireless arrangement, amongst others. Alternatively the interface 1811 may be configured to receive a stream of image data via the connection 1823. The imaging apparatus 1899 may be configured as a microscope or other imaging apparatus and has an imaging source 1898, such as an X-ray source. Raw image data captured by the sensor 140 is typically stored in the HDD 1810 for subsequent processing, including that according to the present disclosure.

The I/O interfaces 1808 and 1813 may afford either or both of serial and parallel connectivity, the former typically being implemented according to the Universal Serial Bus (USB) standards and having corresponding USB connectors (not illustrated). Storage devices 1809 are provided and typically include a hard disk drive (HDD) 1810. Other storage devices such as a floppy disk drive and a magnetic tape drive (not illustrated) may also be used. An optical disk drive 1812 is typically provided to act as a non-volatile source of data. Portable memory devices, such optical disks (e.g., CD-ROM, DVD, Blu ray Disc™), USB-RAM, portable, external hard drives, and floppy disks, for example, may be used as appropriate sources of data to the system 1800.

The components 1805 to 1813 of the computer module 1801 typically communicate via an interconnected bus 1804 and in a manner that results in a conventional mode of operation of the computer system 1800 known to those in the relevant art. For example, the processor 1805 is coupled to the system bus 1804 using a connection 1818. Likewise, the memory 1806 and optical disk drive 1812 are coupled to the system bus 1804 by connections 1819. Examples of computers on which the described arrangements can be practised include IBM-PC's and compatibles, Sun Sparcstations, Apple Mac™ or a like computer systems.

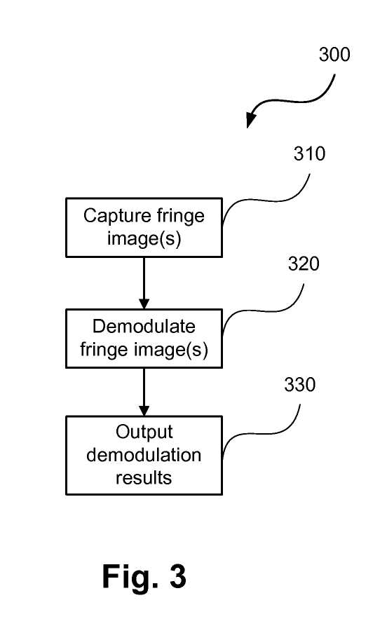

The methods of image demodulation described herein may be implemented using the computer system 1800 wherein the processes of FIGS. 3 to 17, to be described, may be implemented as one or more software application programs 1833 executable within the computer system 1800. In particular, the image demodulation steps are effected by instructions 1831 (see FIG. 18B) in the software 1833 that are executed and carried out within the computer system 1800. The software instructions 1831 may be formed as one or more code modules, each for performing one or more particular tasks. The software may also be divided into two separate parts, in which a first part and the corresponding code modules performs the demodulation methods and a second part and the corresponding code modules manage a user interface between the first part and the user.

The software may be stored in a computer readable storage medium, including the storage devices described below, for example. The software is loaded into the computer system 1800 from the computer readable medium, and then executed by the computer system 1800, and more particularly by the processor 1805. A computer readable storage medium having such software or computer program recorded on the computer readable storage medium is a computer program product. The use of the computer program product in the computer system 1800 preferably effects an advantageous apparatus for image demodulation.

The software 1833 is typically stored in the HDD 1810 or the memory 1806. The software is loaded into the computer system 1800 from a computer readable medium, and executed by the computer system 1800. Thus, for example, the software 1833 may be stored on an optically readable disk storage medium (e.g., CD-ROM) 1825 that is read by the optical disk drive 1812. A computer readable storage medium having such software or computer program recorded on it is a computer program product.

In some instances, the application programs 1833 may be supplied to the user encoded on one or more CD-ROMs 1825 and read via the corresponding drive 1812, or alternatively may be read by the user from the network 1820. Still further, the software can also be loaded into the computer system 1800 from other computer readable media. Computer readable storage media refers to any non-transitory tangible storage medium that provides recorded instructions and/or data to the computer system 1800 for execution and/or processing. Examples of such storage media include floppy disks, magnetic tape, CD-ROM, DVD, Blu-ray Disc™, a hard disk drive, a ROM or integrated circuit, USB memory, a magneto-optical disk, or a computer readable card such as a PCMCIA card and the like, whether or not such devices are internal or external of the computer module 1801. Examples of transitory or non-tangible computer readable transmission media that may also participate in the provision of software, application programs, instructions and/or data to the computer module 1801 include radio or infra-red transmission channels as well as a network connection to another computer or networked device, and the Internet or Intranets including e-mail transmissions and information recorded on Websites and the like.

The second part of the application programs 1833 and the corresponding code modules mentioned above may be executed to implement one or more graphical user interfaces (GUIs) to be rendered or otherwise represented upon the display 1814. Through manipulation of typically the keyboard 1802 and the mouse 1803, a user of the computer system 1800 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 1817 and user voice commands input via the microphone 1880.

FIG. 18B is a detailed schematic block diagram of the processor 1805 and a “memory” 1834. The memory 1834 represents a logical aggregation of all the memory modules (including the HDD 1809 and semiconductor memory 1806) that can be accessed by the computer module 1801 in FIG. 18A.

When the computer module 1801 is initially powered up, a power-on self-test (POST) program 1850 executes. The POST program 1850 is typically stored in a ROM 1849 of the semiconductor memory 1806 of FIG. 18A. A hardware device such as the ROM 1849 storing software is sometimes referred to as firmware. The POST program 1850 examines hardware within the computer module 1801 to ensure proper functioning and typically checks the processor 1805, the memory 1834 (1809, 1806), and a basic input-output systems software (BIOS) module 1851, also typically stored in the ROM 1849, for correct operation. Once the POST program 1850 has run successfully, the BIOS 1851 activates the hard disk drive 1810 of FIG. 18A. Activation of the hard disk drive 1810 causes a bootstrap loader program 1852 that is resident on the hard disk drive 1810 to execute via the processor 1805. This loads an operating system 1853 into the RAM memory 1806, upon which the operating system 1853 commences operation. The operating system 1853 is a system level application, executable by the processor 1805, to fulfil various high level functions, including processor management, memory management, device management, storage management, software application interface, and generic user interface.

The operating system 1853 manages the memory 1834 (1809, 1806) to ensure that each process or application running on the computer module 1801 has sufficient memory in which to execute without colliding with memory allocated to another process. Furthermore, the different types of memory available in the system 1800 of FIG. 18A must be used properly so that each process can run effectively. Accordingly, the aggregated memory 1834 is not intended to illustrate how particular segments of memory are allocated (unless otherwise stated), but rather to provide a general view of the memory accessible by the computer system 1800 and how such is used.

As shown in FIG. 18B, the processor 1805 includes a number of functional modules including a control unit 1839, an arithmetic logic unit (ALU) 1840, and a local or internal memory 1848, sometimes called a cache memory. The cache memory 1848 typically includes a number of storage registers 1844-1846 in a register section. One or more internal busses 1841 functionally interconnect these functional modules. The processor 1805 typically also has one or more interfaces 1842 for communicating with external devices via the system bus 1804, using a connection 1818. The memory 1834 is coupled to the bus 1804 using a connection 1819.

The application program 1833 includes a sequence of instructions 1831 that may include conditional branch and loop instructions. The program 1833 may also include data 1832 which is used in execution of the program 1833. The instructions 1831 and the data 1832 are stored in memory locations 1828, 1829, 1830 and 1835, 1836, 1837, respectively. Depending upon the relative size of the instructions 1831 and the memory locations 1828-1830, a particular instruction may be stored in a single memory location as depicted by the instruction shown in the memory location 1830. Alternately, an instruction may be segmented into a number of parts each of which is stored in a separate memory location, as depicted by the instruction segments shown in the memory locations 1828 and 1829.

In general, the processor 1805 is given a set of instructions which are executed therein. The processor 1805 waits for a subsequent input, to which the processor 1805 reacts to by executing another set of instructions. Each input may be provided from one or more of a number of sources, including data generated by one or more of the input devices 1802, 1803, data received from an external source across one of the networks 1820, 1822, data retrieved from one of the storage devices 1806, 1809 or data retrieved from a storage medium 1825 inserted into the corresponding reader 1812, all depicted in FIG. 18A. The execution of a set of the instructions may in some cases result in output of data. Execution may also involve storing data or variables to the memory 1834.

The disclosed image demodulation arrangements use input variables 1854, which are stored in the memory 1834 in corresponding memory locations 1855, 1856, 1857. The arrangements produce output variables 1861, which are stored in the memory 1834 in corresponding memory locations 1862, 1863, 1864. Intermediate variables 1858 may be stored in memory locations 1859, 1860, 1866 and 1867.

Referring to the processor 1805 of FIG. 18B, the registers 1844, 1845, 1846, the arithmetic logic unit (ALU) 1840, and the control unit 1839 work together to perform sequences of micro-operations needed to perform “fetch, decode, and execute” cycles for every instruction in the instruction set making up the program 1833. Each fetch, decode, and execute cycle comprises:

(i) a fetch operation, which fetches or reads an instruction 1831 from a memory location 1828, 1829, 1830;

(ii) a decode operation in which the control unit 1839 determines which instruction has been fetched; and

(iii) an execute operation in which the control unit 1839 and/or the ALU 1840 execute the instruction.

Thereafter, a further fetch, decode, and execute cycle for the next instruction may be executed. Similarly, a store cycle may be performed by which the control unit 1839 stores or writes a value to a memory location 1832.

Each step or sub-process in the processes of FIGS. 3 to 17 is associated with one or more segments of the program 1833 and is performed by the register section 1844, 1845, 1846, the ALU 1840, and the control unit 1839 in the processor 1805 working together to perform the fetch, decode, and execute cycles for every instruction in the instruction set for the noted segments of the program 1833.

The methods of image demodulation may alternatively or additionally be implemented in dedicated hardware such as one or more integrated circuits performing the functions or sub functions of image demodulation. Such dedicated hardware may for example include digital signal processors, or one or more ASICs, FPGAs, microprocessors and associated memories, for example specifically configured to perform special demodulation processing functions, such as Fourier transforms.

FIG. 3 shows an image capture and demodulation process 300 that may be implemented using the system 1800 including the imaging apparatus 1899. The process 300 may be implemented by a software application stored on the HDD 1810 and executable by the processor 1805. In an initial step 310, one or more fringe images of the sample 102 are captured by the apparatus 1899 via the sensor 140 and corresponding raw image data is stored in the computer module 1801, typically upon the HDD 1810. The process 310 then, according to step 320, performs a demodulation of one or more of the fringe images. This typically involves loading the image being demodulated to the memory 1806 whereupon the processor 1805 executes various demodulation processes, to be detailed below, on the raw image data to form a corresponding demodulated image. The demodulated image, and where required one or more intermediary images formed during the demodulation process 320, are stored on the HDD 1810. In step 330, the demodulation results are output. This may involve display of one or more of the stored images on the display 1814, storing the images to a portable storage media such as a CD or DVD via the drive 1812, or the like, printing the images via the printer 1815, or communicating the images via the network 1820 for remote reproduction and/or further processing.

Overview

The presence of off-axis terms in the spectrum causes cross-talk during demodulation and hence degrades the quality of the demodulated image. Unfortunately, in real X-ray Talbot systems the output of the system is not a good match to the modulation model given by Equation 2. The consequences of this are that the logarithmic mapping explained above does not work well in practice. Disclosed in this section is a more general model of the modulation process that fits better with the experimental data from an X-ray Talbot system.

It is desired to find a transformation that removes the cross-terms from the fringe pattern while allowing separation of the x and y modulation fringes without corruption from the overlap between them and the cross-terms. To achieve this it is appropriate to first investigate the simpler problem of removing a single cross-term in the upper quadrant of the Fourier transform. Consider the simplified model of the first quadrant:

Q(x,y)=A[1+ae^{iΦ}^{ₓ}+be^{iΦ}^{_{y}}+ce^{i(Φ}^{ₓ}^{+Φ}^{_{y}}⁾], [5]

Now consider a general non-linear function that can remove the cross-term e^{i(Φ}^{ₓ}^{+Φ}^{_{y}}⁾ from the image Q. Note that only a non-linear function can have the property of removing the cross-term when the cross-term is not separable in the Fourier or spatial domain. The Taylors series of a general nonlinear function h(Q) analytic at Q=Q₀ is given by:

h(Q)=Σⱼ₌₀^{∞}hⱼ(Q−Q₀)^{j}, [6]

where the coefficients hⱼ specify the function completely.

By expanding h(Q) about Q=A the following expansion in the harmonics of the phase images Φₓ and Φ_{y} is obtained:

$$h ( Q ) = {\sum }_{j = 0}^{∞} {{h}_{j} [ Q - A ]}^{j} = {\sum }_{k = 0}^{∞} {\sum }_{l = 0}^{∞} {C}_{k , l} {e}^{i k {Φ}_{x}} {e}^{i l {Φ}_{y}}$$

where C_{k,l} is the element of the cross-coefficient matrix C at the position (k,l). Assuming, without loss of generality, that A=1; then, the coefficient matrix for the function defined in Equation 5 with entries up to k≦3, and l≦3 is given by:

$$C = [ \begin{matrix}{h}_{0} & {bh}_{1} & {b}^{2} {h}_{2} & {b}^{3} {h}_{3} \\ {ah}_{1} & 2 {abh}_{2} + {ch}_{1} & b ( 3 {abh}_{3} + 2 {ch}_{2} ) & {b}^{2} ( 4 {abh}_{4} + 3 {ch}_{3} ) \\ {a}^{2} {h}_{2} & a ( 3 {abh}_{3} + 2 {ch}_{2} ) & \begin{matrix}6 {a}^{2} {b}^{2} {h}_{4} + \\ 6 {abch}_{3} + {c}^{2} {h}_{2}\end{matrix} & \begin{matrix}b ( 10 {a}^{2} {b}^{2} {h}_{5} + \\ 12 {abch}_{4} + 3 {c}^{2} {h}_{3} )\end{matrix} \\ {a}^{3} {h}_{3} & {a}^{2} ( 4 {abh}_{4} + 3 {ch}_{3} ) & \begin{matrix}a ( 10 {a}^{2} {b}^{2} {h}_{5} + \\ 12 {abch}_{4} + 3 {c}^{2} {h}_{3} )\end{matrix} & \begin{matrix}20 {a}^{3} {b}^{3} {h}_{6} + \\ 30 {a}^{2} {b}^{2} {ch}_{5} + \\ 12 {abc}^{2} {h}_{4} + {c}^{3} {h}_{3}\end{matrix}\end{matrix} ]$$

It can be seen in this case that it is possible to solve for the coefficients of the function h iteratively by setting each cross term to zero. Also note that the matrix has a symmetric relationship about the main diagonal such that:

a^{k-1}C_{k,l}=b^{k-l}C_{l,k}, [7]

Accordingly, where C_{k,l}=0 then C_{l,k}=0, in order to zero the off-axis terms only requires the coefficients in the upper triangle of the matrix to be solved. However, it is not obvious that all off-axis terms can be solved uniquely as there are more terms in any finite upper triangle of the matrix than there are coefficients. However, in the special case of Equation 5, series coefficients for the function h(Q) can be obtained which set to zero the coefficients of all off-axis terms:

$${h}_{j} = {( - 1 )}^{j - 1} \frac{1}{j} {( \frac{c}{ab} )}^{j - 1} , \qquad [ 8 ]$$

where by definition, h₀=0. This corresponds to the expected logarithmic relationship that is derived in a more direct manner later:

$$h ( Q ) = \frac{ab}{c} log ( 1 + \frac{c}{ab} Q ) . \qquad [ 9 ]$$

The logarithmic relationship of Equation 9 typically cannot be applied directly to Equation 2 as usually the off-axis term amplitudes are not known. Additionally, in Equation 2 the two off-axis terms can be of different amplitudes and in this case it is not possible to factorize the x and y dependent parts of the equation exactly.

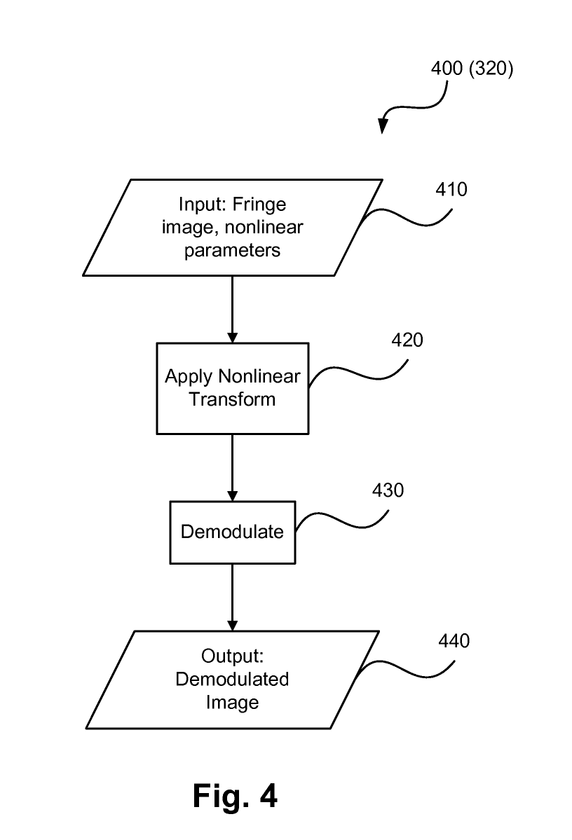

However, the existence of a nonlinear function that reduces off-axis spectra suggests an algorithm for demodulating a single-shot image using this function to improve quality of the demodulated image. An example algorithm is shown in a demodulation process 400 of FIG. 4, which may be used as an implementation of the demodulation step 320.

In FIG. 4, an input 410 to the process 400 is an image containing fringes, including on-axis terms and off-axis terms, and parameters for a nonlinear transform. A first step 420 of the process 400 is to perform a nonlinear transformation of the pixels in the input image 410 to attenuate the off-axis spectra. The nonlinear transformation is described by the input parameters. This nonlinear transform is not restricted to a logarithmic function. Nevertheless, the nonlinear transform should possess the properties of reducing the relative off-axis power as well as limiting the power in higher on-axis harmonics.

After off-axis terms have been attenuated by step 420, any appropriate approach may be used for demodulating the image in a demodulate step 430. One example is the windowed Fourier transform method. Note that demodulation of an image containing multiple sets of fringes will result in multiple demodulated images, and that it is not necessary to demodulate any except the desired on-axis fringes.

The output of the process 400 is a demodulated image 440.

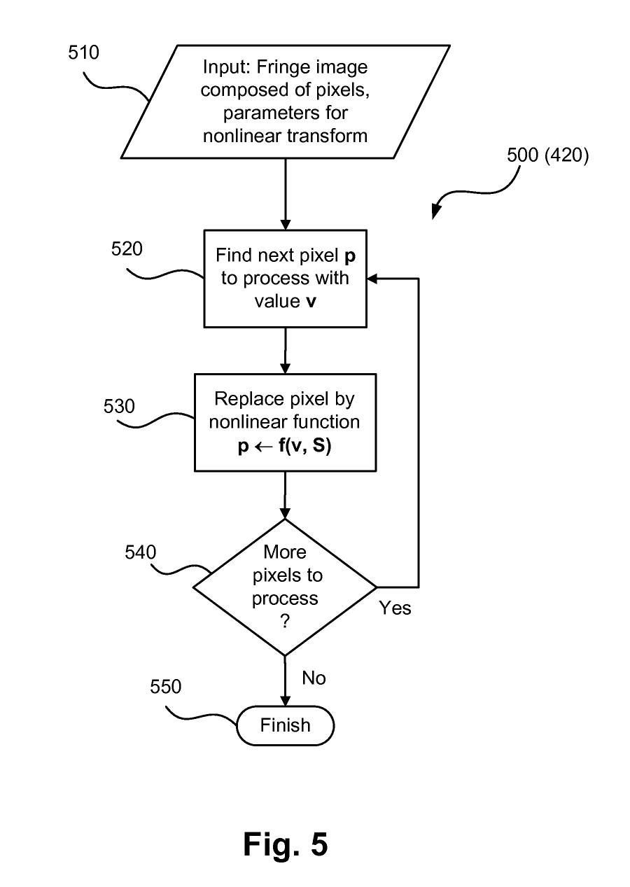

A preferred process 500 of applying a nonlinear transformation of step 420 is shown in FIG. 5. The input 510 to the process 500 is an image containing fringes, including on-axis terms and off-axis terms, expressed as pixels p with values v and parameters S for a nonlinear transformation, f(v,S).

In step 520, an unprocessed pixel pᵢ from the image is selected with value vᵢ.

In step 530, the pixel pᵢ is replaced by an evaluation of the nonlinear transformation, (vᵢ,S).

In step 540, if there are more pixels to be processed, control is returned to step 520, otherwise the process 500 completes at step 550, leaving an image processed by a nonlinear transformation.

Although the method 500 attenuates the off-axis terms and hence reduces cross-talk, the use of a nonlinear function will also generate harmonics of the on-axis terms, resulting in extraneous signal which might also reduce image quality.

A variation on the process of FIG. 4 allows for the suppression of both off-axis terms and harmonics during the demodulation process.

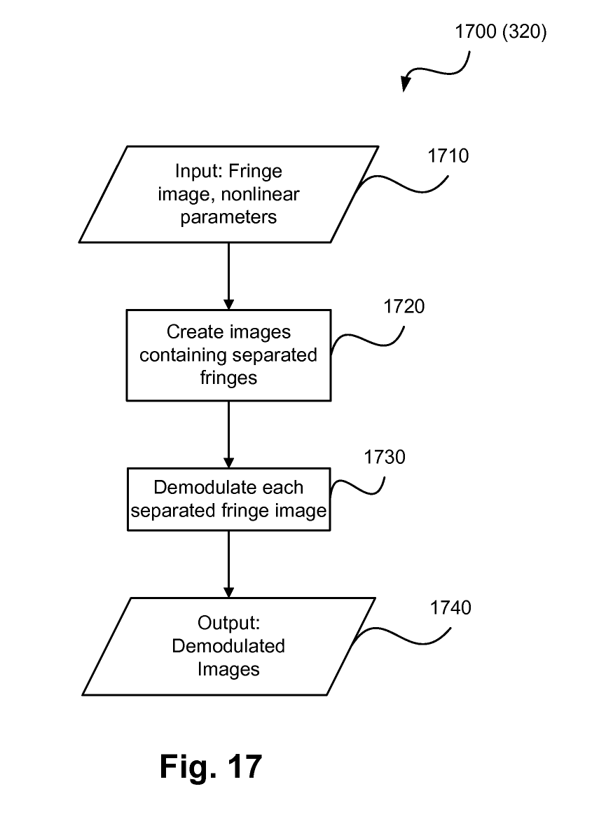

FIG. 17 shows a demodulation process 1700, slightly different from that depicted in FIG. 4, which divides the demodulation process into two parts. Like FIG. 4, an input 1710 to the process 1700 is a fringe image containing on-axis terms and off-axis terms to be demodulated.

In step 1720 the input image 1700 is processed to yield multiple real images, with each image containing separated fringe patterns. Note that it is not necessary to produce any image other than images of the on-axis fringes. Step 1720 desirably should incorporate processing to suppress off-axis spectra and generated harmonics. Methods for doing this processing are discussed later.

In step 1730, each separated fringe image is demodulated to yield a demodulated image for each of the desired on-axis frequencies. Again, appropriate known demodulation approaches may be used. In step 1740, the demodulated images are output.

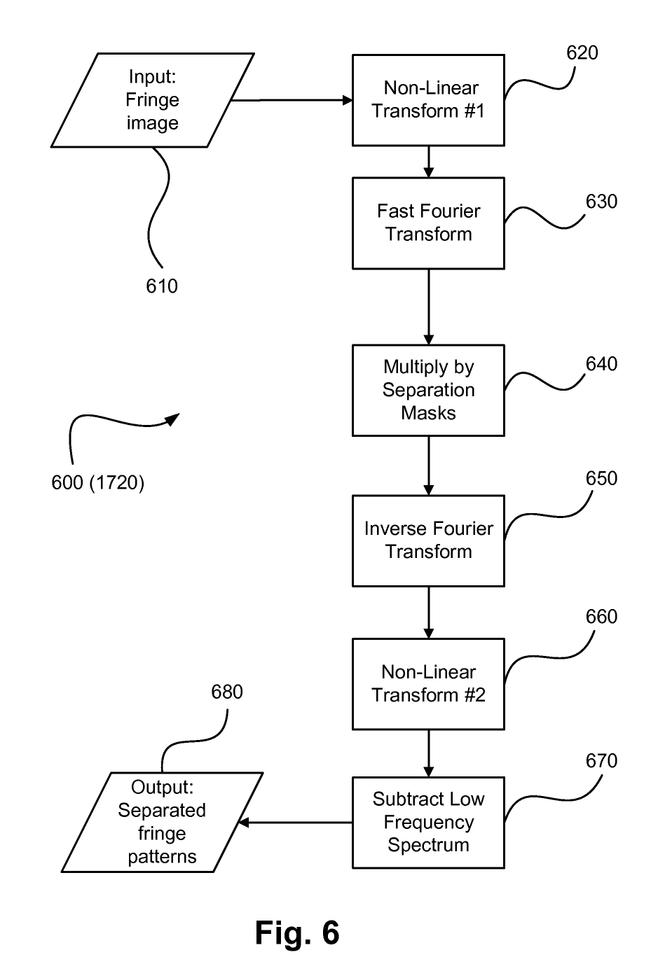

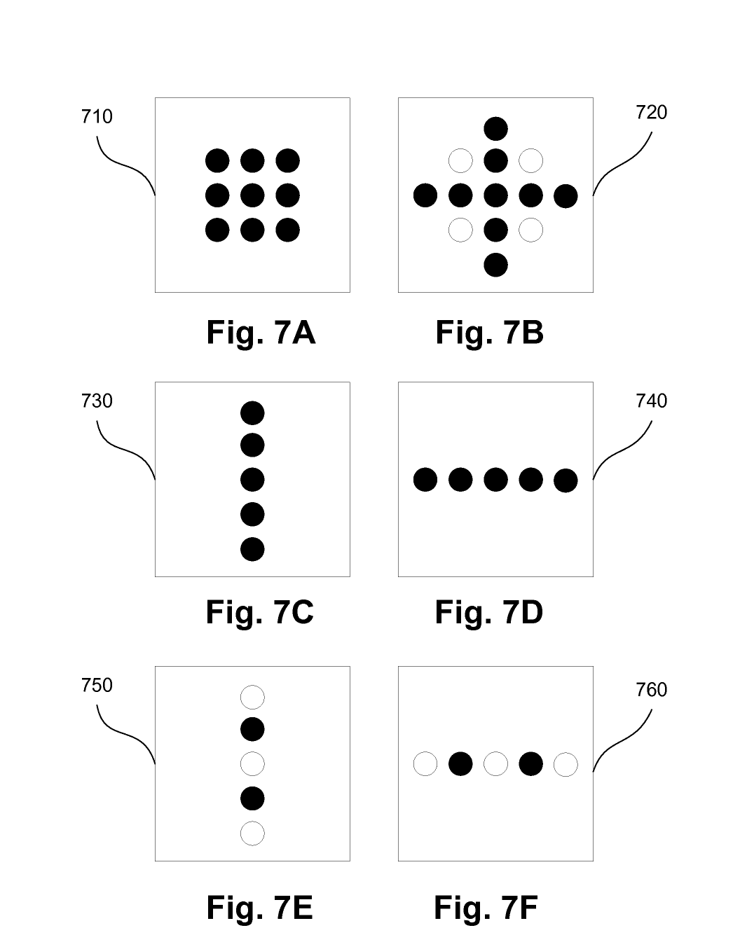

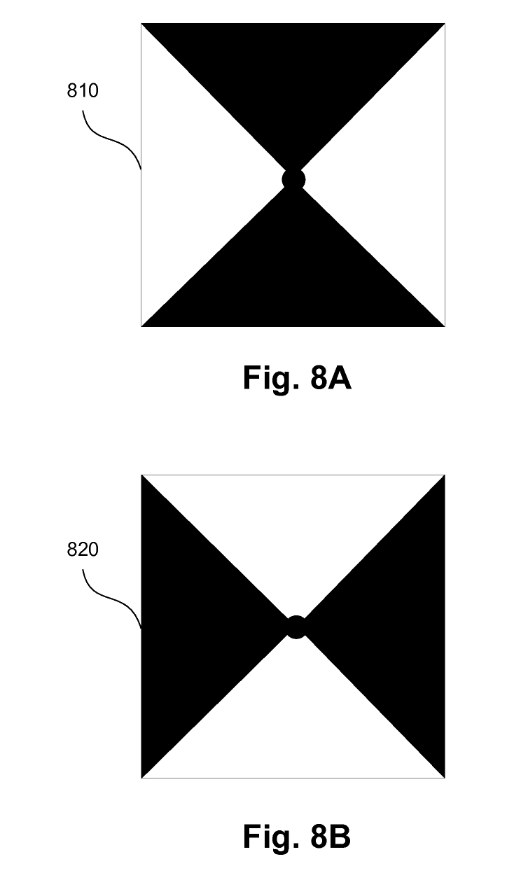

A preferred single-shot process 600 to separate on-axis terms and to suppress both off-axis terms and harmonics, as used in step 1720, is described in FIG. 6, with reference to explanatory diagrams in FIGS. 7A-7F and 8A and 8B.

FIGS. 7A-7F illustrate the sequential appearance of the image in the Fourier domain as processing progresses, although it should be noted that some steps of the process 600 are applied in the spatial domain.

FIGS. 8A and 8B illustrate two binary masks 810, 820 used to separate the x and the y carrier frequencies in the Fourier domain, with black representing a value of ‘1’, and white representing a value of ‘0’. Each mask 810, 820 is constructed with four quadrants in the plane, with two quadrants containing ‘1’ being centred on the on-axis terms being preserved, and two quadrants containing ‘0’ centred on the on-axis terms being removed, and a disk of approximately 5% of the image width containing ‘1’ to preserve the low-frequency terms near DC. The mask 810 is the mask Sₓ, used to select the carrier for the x phase derivative, which is centred on the y axis, and the mask 820 is the mask S_{y}, used to select the y carrier. These masks are convolved with a Gaussian filter before use to reduce any ringing artefacts resulting from their sharp edges in the Fourier domain.

The input 610 to the process 600 is a single fringe image and two parameterized non-linear transforms, a first transform h and a second transform g. The Fourier transform of the input image will appear similar to the diagram 710 of FIG. 7A, with nine spectral regions corresponding to the absorption spectrum (low frequencies about the DC term) at the centre, the on-axis terms and their corresponding Hermitian pairs horizontally and vertically adjacent to the DC term, and the off-axis terms and their corresponding Hermitian pairs diagonally adjacent to the DC term.

In step 620 the first nonlinear transform h is applied to the input image using the process described in FIG. 5. Step 620 operates to attenuate the off-axis terms, and generate harmonics of the on-axis terms. This results in a change of the spectrum to that of the function 720 as represented in FIG. 7B, where the open circles represent the attenuated off-axis terms, and the new dark circles adjacent to the on-axis terms represent the harmonics.

In step 630, a real Fast Fourier Transform (FFT) is applied to the image to transform the image from the spatial domain to the Fourier (frequency) domain. The result is a complex image with Hermitian symmetry.

In step 640, the result of the Fast Fourier Transform is multiplied by the sum of the two spectral masks, Sₓ (810) and i S_{y} (820), where i=\sqrt{−1}. This multiplication separates the spectrum of the Fourier transform into regions containing substantially x and y carriers.

In step 650, the inverse complex Fast Fourier Transform is applied to produce two fringe patterns, separated with the x carrier in the real part of the image, and the y carrier in the imaginary part of the image. This is shown diagrammatically, with the spectrum 730 of FIG. 7C showing the real part of the image, with absorption spectrum being the central circle, the Hermitian pair of the desired on-axis x carriers adjacent to the central circle, and the undesired harmonics represented at the end points. Similarly, the spectrum 740 of FIG. 7D shows the spectrum of the imaginary part of the image which contains the y carriers.

In step 660, the second non-linear transformation g is applied to each fringe pattern 730, 740 independently so as to attenuate the harmonics, and in step 670 a low-frequency spectrum is computed and subtracted from each fringe pattern to produce zero-mean separated fringes. Such a low-frequency spectrum can be computed by fitting 25 terms computed separably from one-dimensional Legendre polynomials of degree 5. This fit is then subtracted from each fringe image 730, 740.

The spectrum of the resulting two fringes 750 and 760 is represented in FIGS. 7E and 7F respectively, with the Hermitian pairs of the on-axis carriers remaining, and the central absorption spectrum (DC component) removed, and the high-frequency harmonics attenuated.

With the off-axis terms, harmonics and absorption spectrum removed, these two fringe images are output in step 680, ready for demodulation.

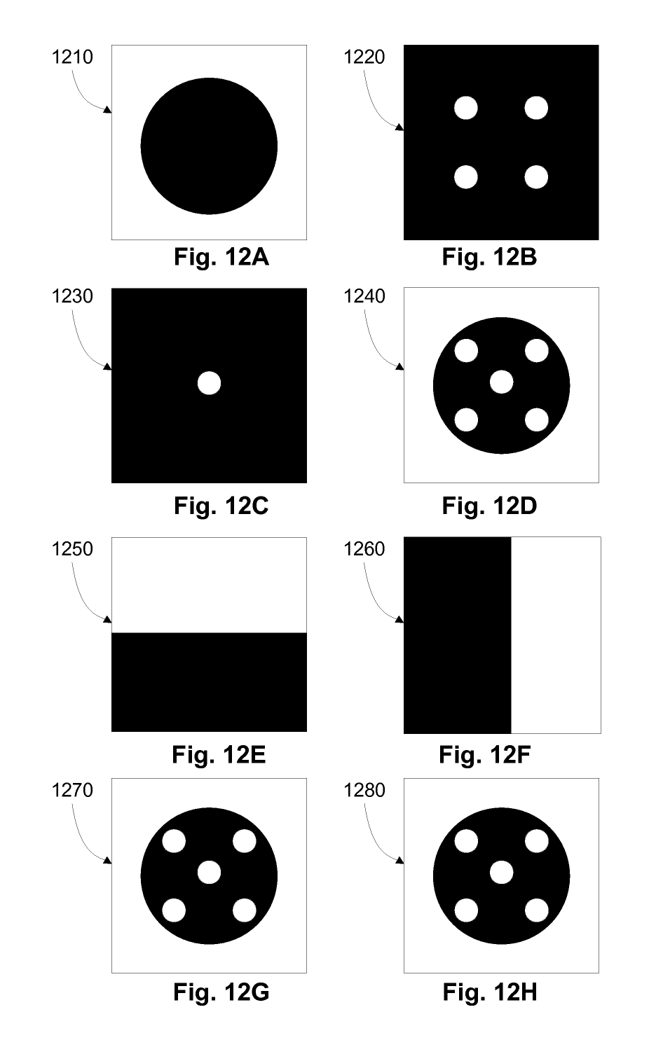

FIGS. 12A-12H illustrate various spectral masks that may be used in the demodulation algorithm. The masks of FIGS. 12A-12H represent preferred implementations of that of FIGS. 8A and 8B with some spectra removed. Two spectral masks are used in the demodulation method, one for the x carrier and one for the y carrier. Each mask has a common part composed of a low-pass filter part 1210 of FIG. 12A, notch filters 1220 to remove residual off-axis terms of FIG. 12B, and a high-pass filter 1230 to remove the lowest frequencies shown in FIG. 12C. The combination of the low-pass, notch and high-pass filters is shown in FIG. 12D as the mask 1240. The masks 1250 and 1260 of FIGS. 12E and 12F respectively use a Hilbert transform to produce the analytic signal, thus restoring the signals to complex quadrature with phases carrying the x and y phase derivatives respectively. Combining the filter mask 1240 with the Hilbert masks 1250 and 1260 gives two custom spectral masks, being a mask 1270 of FIG. 12G for the x carrier, and a mask 1280 of FIG. 12H for the y carrier.

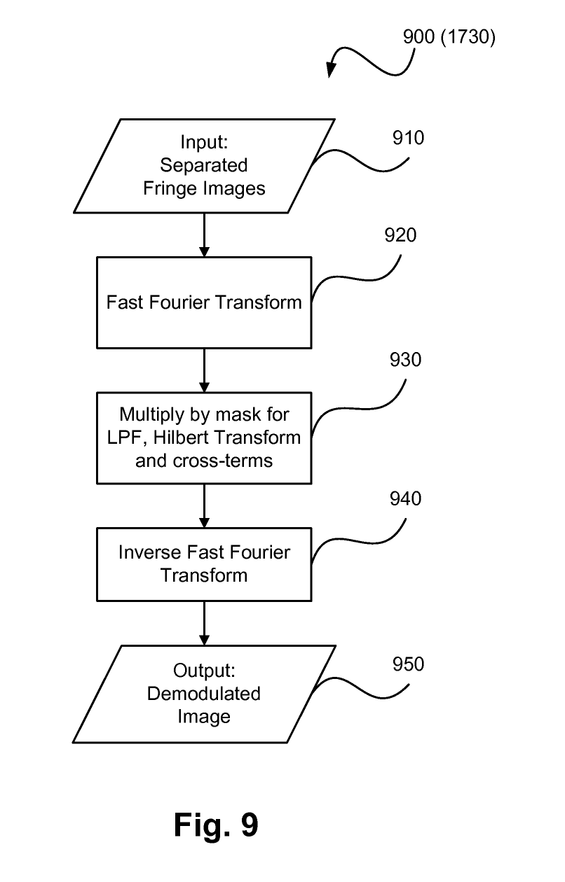

FIG. 9 describes a method 900 to demodulate the separated fringe images using the masks defined in FIGS. 12G and 12H, thereby representing a preferred implementation of step 1730 of FIG. 17. The method 900 takes as input 910 the separated x and y fringe images as produced by the procedure of FIG. 6. A Fourier transform for each of the x and y fringe images is then computed at step 920.

In step 930 each Fourier transform is multiplied by the corresponding Hilbert and filter mask 1270 and 1280. The filters remove the lowest frequencies, residual off-axis spectra, and have a low-pass effect to remove noise and aliasing from the demodulation process. The Hilbert mask removes the Hermitian pairs in the Fourier transform, leaving only positive frequencies, and thus restores the quadrature phase part of the fringes.

In step 940, the inverse Fourier transform is applied to the masked fringes thereby returning the demodulated images to the spatial domain,

A pair of demodulated images is the output at step 950 of the process 900, and these images contain both real and imaginary parts in quadrature, from which the amplitude and wrapped phase can be computed directly.

Given a model for the images produced by the imaging system 100, a matched pair of parameterized nonlinear functions as shown in steps 620 and 660 in FIG. 6 must be derived for the purpose of, firstly, removing off-axis terms, and, secondly, removing the harmonics generated by the first nonlinear function. Two approaches are now described to create this matched pair of nonlinear functions.

The first approach is to generate a pair of nonlinear functions to minimize the amplitudes of off-axis terms and harmonics, given the values of the coefficients mₓ, m_{y}, mᵤ, mᵥ. If these coefficients have constant values across the input image, then a pair of nonlinear functions can be derived to minimize the amplitude of the off-axis terms and the harmonics resulting from the process 600 of FIG. 6.

The second approach is to gather image samples to demodulate along with the measured ground truth. This can give highly accurate estimates of the modulation artifacts A, mₓ, m_{y}, mᵤ, mᵥ, ωₓ and ω_{y}. An optimisation process may then be used to derive a pair of nonlinear functions which minimise the error in an image demodulated using the methods in FIGS. 6 and 9.

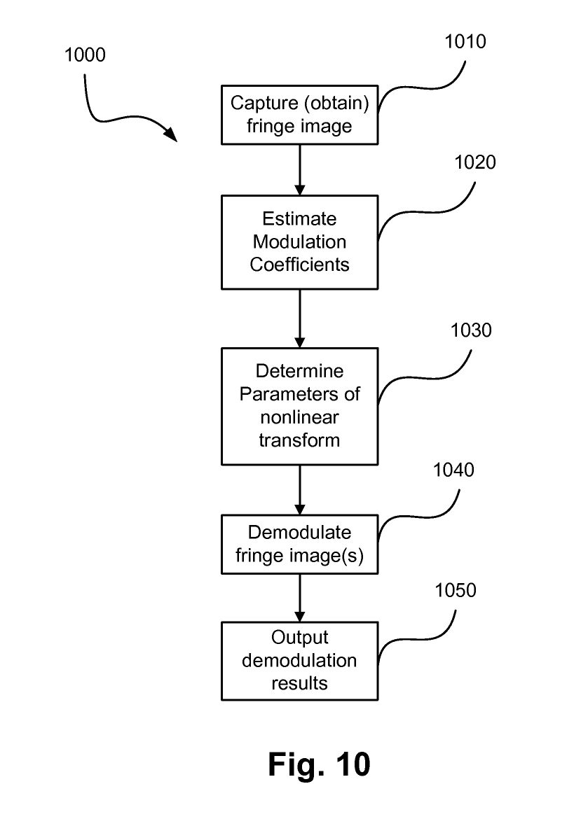

FIG. 10 shows a method 1000 for demodulating an image using non-linear functions generated according to the first approach. The method 1000 may be implemented in software, stored on the HDD 1810 for example, and executed by the processor 1805

In step 1010, an input fringe image containing four fringe patterns is captured or otherwise obtained, from storage for example. In step 1010, there is no need for an object 102 to be present. In step 1020, the fringe image is analysed to estimate the values for the modulation coefficients mₓ, m_{y}, mᵤ, mᵥ for the fringe image, either globally in aggregate, or locally at each pixel position. These values can be estimated globally by computing the amplitudes A, Fₓ, F_{y}, Fᵤ, Fᵥ of the DC and corresponding carrier frequency peaks in the Fourier transform of a calibration image captured using the imaging system 100 including relevant ones of the gratings 101, 110, 130, but containing no object 102, and then computing mₓ=Fₓ/A, m_{y}=F_{y}/A, and so on. The estimated modulation coefficients mₓ, m_{y}, mᵤ, mᵥ represent properties of the X-ray Talbot interferometer 100. These values can be computed locally by the processor 1805 performing a trial demodulation of the image using another demodulation algorithm. Example of such algorithms include a traditional Fourier method, and a Windowed Fourier Transform (WFT). In step 1030, the parameters for the nonlinear transforms are calculated from the modulation coefficients mₓ, m_{y}, mᵤ, mᵥ estimated in step 1020 to reduce the off-axis terms and harmonics, and in step 1040 the image is demodulated, preferably using the method described in FIGS. 6 and 9.

In real X-ray Talbot imaging systems, the modulation process is complex and does not match simple theoretical models. Therefore, it is difficult to use measured modulation and amplitude parameters to choose the parameters of the nonlinear functions used to reduce off-axis terms. In particular, the amplitudes of the modulation coefficients are not constant, with their values at a maximum in the case that X-rays are undeviated and the bandwidth of the spectra are small, and with their values decreasing towards zero where the X-rays are deflected by the object, for example at the interface between different materials. In these positions the bandwidth of the modulated carriers is at a maximum. In extreme cases, the modulation coefficients can become negative.

The values of mₓ, m_{y}, mᵤ, mᵥ will drop locally in the presence of steep phase gradients. For example, where the magnitude of the phase gradient in the x direction is large, the value of mₓ will drop, and drop towards zero with extremely steep gradients, and the same for the other modulation values, with the off-axis terms mᵤ and mᵥ being associated with phase gradients at 135° and 45° respectively.

The pair of nonlinear functions can be chosen either globally or locally. If the functions are chosen globally, they should be selected to reduce the off-axis terms for the modulation coefficients which would be expected to contribute most to cross-talk distortion in the image. The selection of these terms is non-obvious, because the bandwidth of a signal associated with no phase gradient is extremely small, yet the amplitude of the high-bandwidth signal associated with a steep phase gradient is also extremely small. Accordingly, based on this understanding, it would be expected that the nonlinear functions should be chosen to reduce off-axis terms for middle-range modulation values.

If the nonlinear functions are chosen based upon local modulation values, these modulation values are not available prior to demodulation and hence must be estimated by a simpler method. Furthermore, if using locally changing nonlinear functions, the inversion of these functions to recover the fringe is non-trival and must be considered carefully.

Because it is difficult to accurately measure modulation values, an alternative approach is described to choose the nonlinear functions used for demodulation, using an optimization process.

The first step in such an approach is to generate one or more modulated images with known ground truth. All of the relevant parameters of a candidate image can be obtained by taking multiple, phase-shifted images, such as 16 images resulting from phase-shifting in the x and y direction with all multiples 90°, and then using a known demodulation method to produce a reference demodulated image. The demodulation parameters can be independently measured on a per pixel basis and are A, mₓ, m_{y}, mᵤ, mᵥ, ωₓ and ω_{y}. Noise is neglected in this analysis, so the images should have sufficient exposure time so that noise is not a significant component of the signal.

Two approaches can be used to obtain a single-shot image for evaluation of the single-shot demodulation process. Firstly, a single input image can be taken from the multiple phase-shifted input images. Secondly, a single input image can be simulated by remodulation of the reference demodulated image. This single-shot demodulated image, demodulated using either approach, is called the candidate demodulated image, and can be compared with the reference demodulated image to evaluate demodulation quality.

This first approach to obtain the candidate demodulated image has the disadvantage that although the demodulation of genuine data is tested, the sources of error in this demodulation will be demodulation error plus signal noise, and any errors in the modulation model. The second approach allows the creation of an image with zero noise and which is described perfectly by the demodulation model, so the sources of error in demodulation can be totally ascribed to the demodulation algorithm.

If the obtained image is demodulated using the single-shot algorithm with candidate parameters for the non-linear functions being used, the quality of the candidate demodulated image, and hence the quality of the parameters, can be evaluated by means of an image quality metric, such as the root-mean-square (RMS) error of the phase.

After executing this process once, the parameters can be modified, and the process repeated. In this way optimal parameters of the parametrised transforms may be found that provide minimal root-mean-square (RMS) error.

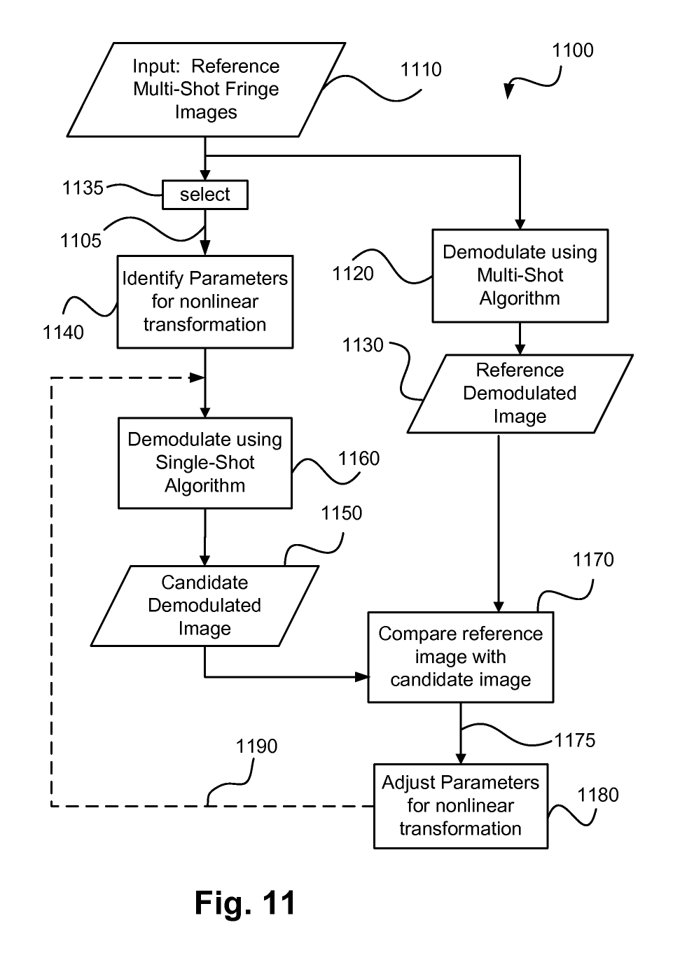

An example 1100 of such a process is shown in FIG. 11. The input 1110 to the process 1100 is a collection of phase-stepped reference fringe images. Typically, the input images 1110 are captured in a controlled set-up environment, such as during factory set-up and calibration of the imaging apparatus 100. The images 1110 are captured at multiple phase variations of the gratings 101, 110 and 130, which may include linear offset (shift) along three axes or rotation. In step 1120 the collection of input images 1110 is demodulated using a high-quality multi-shot, or phase-stepped, algorithm, to form a reference demodulated image 1130. In step 1135, a single image 1105 is selected from the collection of input images 1110 to form an input to a single-shot demodulation process. Any single image from the collection 1110 may be selected for single-shot processing.

In step 1140, the processor 1805 operates to identify candidate parameters for the single-shot demodulation process. These parameters include, but are not limited to, the parameters describing the nonlinear functions used in the demodulation process. Typically, the parameters comprise initial estimates that are recorded in memory, such as the HDD 1810. The initial estimates may be predetermined as factory setting or alternatively or additionally retained in memory from previous instantiations of the process 1100.

In step 1160, the selected one image 1105 is demodulated using the parameters identified in step 1140 according to the single-shot demodulation process 600, as described in FIG. 6, resulting in a candidate demodulated image 1150.

In step 1170, the candidated demodulated image 1150 is compared to the reference demodulated image 1130, to form an error estimate 1175.

The final step 1180 of the process 1100 is where the processor 1805 uses the error estimate 1175 to adjust the parameters of the demodulation process, including the nonlinear transforms identified at step 1140, thereby provided adjusted demodulation parameters and nonlinear transforms.

Using any of a number of optimization procedures, such as the Simplex method, brute-force search, or gradient-descent methods, the process in FIG. 11 can desirably be repeated by returning the adjusted parameters of step 1180 to be input to the single-shot demodulation process 1160, as indicated by the dashed return line 1190. The consequence of the chosen optimization procedure is that the error estimate 1175 is reduced or otherwise refined, thus leading to improved parameters for the demodulation algorithm 1160. The repeating may continue until the error falls below a predetermined limit, for a predetermined number of iterations, or until the error stops improving.

First Specific Implementation

The use of nonlinear functions to reduce off-axis terms depends critically on the relative amplitude of the modulation parameters mₓ, m_{y}, mᵤ, and mᵥ. In the specific case that the off-axis terms have an amplitude identical to that of the product of the on-axis term amplitudes when formed from a product, i.e.,

$$\begin{matrix}I = A [ 1 + {m}_{x} cos ( {ω}_{x} x + {Φ}_{x} ( r ) ) ] [ 1 + {m}_{y} cos ( {ω}_{y} y + {Φ}_{y} ( r ) ) ] \\ = A [ 1 + {m}_{x} cos ( {ω}_{x} x + {Φ}_{x} ( r ) ) + {m}_{y} cos ( {ω}_{y} y + {Φ}_{y} ( r ) ) + \\ \frac{{m}_{x} {m}_{y}}{2} cos ( {ω}_{x} x + {ω}_{y} y + {Φ}_{x} ( r ) + {Φ}_{y} ( r ) ) + \\ \frac{{m}_{x} {m}_{y}}{2} cos ( {ω}_{x} x - {ω}_{y} y + {Φ}_{x} ( r ) - {Φ}_{y} ( r ) ) ] ,\end{matrix} \qquad [ 10 ]$$

where we have ignored the noise Sᵢ from Equation 2. In this case the off-axis terms correspond directly to the multiplicative cross-terms, and can be removed with a first non-linear function being f(I)=log I, and the harmonics removed with a second non-linear function being g(I)=exp I. This gives the theoretical response after the first nonlinear function as:

g(I)=log A+log [1+mₓ cos(ωₓx+Φₓ(r))]+log [1+m_{y} cos(ω_{y}y+Φ_{y}(r))]

This special case corresponds to the use of homomorphic filtering. However, the signal being a perfect product of x and y modulations is unlikely to arise in practice. This is because the physical processes giving rise to the off-axis terms do not correspond to the product of two one-dimensional cosine functions.

The X-ray Talbot imaging system does not produce images which fit this model. Instead the off-axis modulations are typically different from the product of on-axis factors, as given by Equation 2. Assuming that the major axes of the modulation are known, or can be determined, it is therefore possible to consider the problem of where to map the coordinates so that the major axes are in the x and y directions. Furthermore, two further diagonal cross-terms, denoted with subscripts u and v, can be considered and that the frequency and phase of the cross-terms are simply the sum and difference of the on-axis phase terms, φₓ, φ_{y}, such that:

ωᵤ·r=ωₓx+ω_{y}y,ωᵥ·r=ωₓx−ω_{y}y, [11]

Φᵤ=Φₓ+Φ_{y},Φᵥ=Φₓ−Φ_{y}. [12]

In this case, an image can be factored as follows:

$$\begin{matrix}I = A [ 1 + {m}_{x} cos ( {φ}_{x} ) + {m}_{y} cos ( {φ}_{y} ) + {m}_{u} cos ( {φ}_{x} + {φ}_{y} ) + \\ {m}_{v} cos ( {φ}_{x} - {φ}_{y} ) ] \\ = A \{ {γ}^{- 1} [ γ + {m}_{x} cos ( {φ}_{x} ) ] [ γ + {m}_{y} cos ( {φ}_{y} ) ] + 1 - γ \} ,\end{matrix} \qquad [ 13 ]$$

where the notation φₓ=ωₓx+Φₓ(r) and φ_{y}=ω_{y}y+Φ_{y}(r) is used for convenience, and the factorizing coefficient is estimated according to the relation:

$$γ = \frac{2 {m}_{x} {m}_{y}}{{m}_{u} + {m}_{v}} . \qquad [ 14 ]$$

Calculation of Equation 13 requires knowledge of the spatially-varying absorption, A(r), and an estimate of the parameter γ. In the ideal case that the off-axis terms are an exact product of the on-axis terms, γ=1. However, typically the cross-terms are larger than expected, and therefore γ<1. Further in this case, A(1−γ) is being subtracted from the image I, and therefore there is a potential for this term to become negative due to image noise and the estimations of A and γ. As the real log function is undefined for zero or negative values, the relevant terms should be clipped below to a small positive value. Also note that in the case that the cross-terms are smaller than expected, γ>1 and a positive value will be added to the signal I and the result will therefore always be greater than zero.

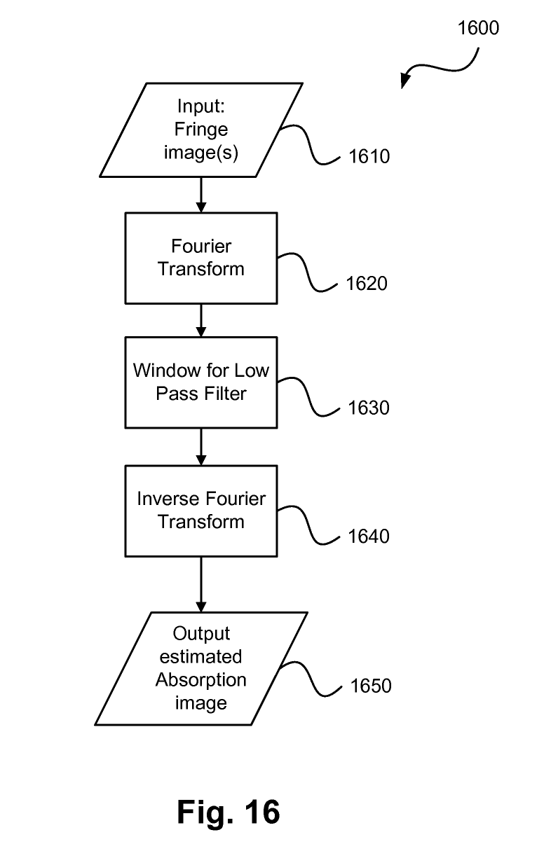

The estimate of the absorption can be made using a low-pass filter having a stop band which removes the modulated carrier frequencies from the image. In most cases, even a band-limited approximation to the absorption is useful, as the higher frequencies are typically at edges where the modulation is low and the assumption that mᵤ=m_{y} breaks down. FIG. 16 shows a process 1600 for estimation of the absorption image A.

The factorizing coefficient γ also needs to be estimated before an offset-log function can be calculated. This requires estimates of all modulation amplitudes mₓ, m_{y}, mᵤ, and mᵥ. A constant estimate of these factors can be formed by calculating the peak signal amplitudes in the Fourier domain near the respective central frequency of each carrier. Alternatively, a low frequency estimate of these quantities can be calculated by filtering the original signal in the Fourier domain and demodulating the resulting signals.

In the case of the experimental system the cross-term modulation amplitudes are typically twice the magnitude of the product of the on-axis modulations. This is a result of the shape of the cells of which the gratings 101, 110 and 130 are composed. There is in fact no multiplicative relationship between the cross-terms and the on-axis terms.

It is also important to note that the modulation functions mₓ, m_{y}, mᵤ and mᵥ do not have constant values across the image. The absorption of the object 102 simply reduces the amount of light (specifically, X-ray electromagnetic energy) reaching the image sensor 140 and is taken into account by the absorption term A that multiplied all terms in Equation 4. However, the modulation amplitude drops by a larger fraction than the absorption. In addition, the modulation values also drop at the edges of structures being imaged, and some materials, such as a paper and wood, cause a drop in modulation disproportionate to their relative small absorption values. This is because of the convolution of the Talbot image by the set of pinholes in the G0 grating 101, and an initial one-dimensional modelling of this source convolution has reproduced many of the same effects that are observed in real data. The result of this convolution is that the modulation drops, sometimes by as much as 90%, where the second derivative of the optical path length is high. This occurs at boundaries between materials, and in structures such as wood and paper with highly-scattering structure. This property is useful, and can be used to determine the position of sharp edges in the images.

Furthermore, the modulation drop occurs in proportion to the inner product between the modulation direction and the direction of the gradient in the optical path length. This means that the cross-term modulation mᵤ is high when the optical path length gradient is at an angle of π/4, and mᵥ is high when the optical path length gradient is at an angle of −π/4. Therefore, these terms can significantly depart from being the product of mₓ and m_{y}.

Some typical mean values of these parameters in real systems are as follows:

Ā=500; m̅ₓ=m̅_{y}=0.1; m̅ᵤ=m̅ᵥ=0.03

where x̅≡mean(x).

In this form the off-axis terms can be removed by use of an offset-log function:

$$\begin{matrix}H ( I ) = log [ I - A ( 1 - γ ) ] \\ = log A - log γ + log ( γ + {m}_{x} cos {φ}_{x} ) + log ( γ + {m}_{y} cos {φ}_{y} )\end{matrix} \qquad [ 15 ]$$

After the offset-log function of Equation 15 is applied, the off-axis cross terms are found to have been significantly reduced and the on-axis terms are therefore separated in the Fourier domain. Separation of the x and y modulated terms in the Fourier domain can then be performed using a filter that accepts the on-axis terms along one axis preferentially. An example of such a filter in the Fourier domain is shown graphically in in FIGS. 8A and 8B.

After this filter has been applied the remaining signal consists of the on-axis terms of one axis preferentially as well as the DC component of the total signal. Note that the DC components of the signal include a component from the other axis modulation signal that cannot be filtered out in the Fourier domain. An estimate of the contribution of this other axis component can be made by taking a series expansion of the logarithm terms about γ, according to the relation:

$$\begin{matrix}log ( γ + {m}_{w} cos {φ}_{w} ) = {\sum }_{k = 1}^{∞} \frac{{( - 1 )}^{k}}{k} {( \frac{{m}_{w}}{γ} cos {φ}_{w} )}^{k} + log γ \\ = {\sum }_{k = - ∞}^{∞} {C}_{k} ( \frac{{m}_{w}}{2 γ} ) exp ( i k {φ}_{w} ) + log γ\end{matrix} \qquad [ 16 ]$$

where w=(x,y) and the coefficients of the terms are given by:

$${C}_{2 k} ( x ) = - {\sum }_{l = max ( \vert k \vert , 1 )}^{∞} \frac{( 2 l - 1 ) !}{( l + k ) ! ( l - k ) !} {x}^{2 l} , \\ {C}_{2 k + 1} ( x ) = {\sum }_{l = \vert k \vert}^{∞} \frac{( 2 l ) !}{( l + k + 1 ) ! ( l - k ) !} {x}^{2 l + 1} . \qquad [ 17 ]$$

Therefore, after the application of the x-separation filter 820 of FIG. 8B to extract the x-modulated signal and the DC component of the total signal (captured image), such may be expressed as a processed fringe signal:

$$\begin{matrix}{S}_{x} \{ H ( I ) \} = log A + log ( γ + {m}_{x} cos {φ}_{x} ) + {C}_{0} ( \frac{{m}_{y}}{2 γ} ) \\ = log A + log ( γ + {m}_{x} cos {φ}_{x} ) - \\ {\sum }_{l = 1}^{∞} \frac{( 2 l - 1 ) !}{( l ! ) 2} {( \frac{{m}_{y}}{2 γ} )}^{2 l}\end{matrix} \qquad [ 18 ]$$

Note that this sum converges for m_{y}/γ<1. Assuming the cross-terms are small relative to the on-axis terms, it is possible to consider only the first term in the expansion. Taking the exponential of the filtered logarithm gives:

$$exp ( {S}_{x} \{ H ( I ) \} ) ≃ A exp ( - {( \frac{{m}_{y}}{2 γ} )}^{2} ) \times ( γ + {m}_{x} cos {φ}_{x} ) . \qquad [ 19 ]$$

Equation 19 shows that it is possible to successfully separate the x-modulated signal from the y-modulated signal except for the presence of the absorption and the effect of the y-modulation amplitude.

To remove the absorption, the expression can be divided by the regularized estimated absorption as previously calculated. An estimate of the x-modulated signal can be arrived at by assuming m_{y}/γ is small, so that

$${\tilde{P}}_{x} = \frac{1}{A + λ} exp ( {S}_{x} \{ H ( I ) \} ) ≃ γ + {m}_{x} cos {φ}_{x} . \qquad [ 20 ]$$

A similar formula for the y-modulated signal is:

$${\tilde{P}}_{y} = \frac{1}{A + λ} exp ( {S}_{y} \{ H ( I ) \} ) ≃ γ + {m}_{y} cos {φ}_{y} . \qquad [ 21 ]$$

To retrieve the phase and amplitude components of the modulated signals it is possible to form the analytic signal by removing the negative frequency components. The analytic signal can be calculated for a either using the FFT or a one-dimensional (1D) spatial filter. A low-pass filter can be additionally applied to remove the residual Fourier components at the cross-term frequencies. This can be achieved by use of the Fourier domain filters shown in FIGS. 12A to 12H, such that:

Tₓ[ƒₓ]≃mₓexp(iφₓ)

T_{y}[ƒ_{y}]≃m_{y}exp(iφ_{y}). [22]

From these filtered signals Tₓ and T_{y}, an estimate of the modulation amplitudes mₓ and m_{y} can be determined from the modulus, a wrapped phase (modulo 2π) using an arctangent with the real and imaginary components of the complex signal.

To obtain an estimate of the true differential phases Φₓ and Φ_{y} of Equation 3, the wrapped phases in the images Tₓ and T_{y} must be unwrapped using some kind of phase unwrapping algorithm.

In X-ray phase contrast imaging there can be extremely large phase transitions that occur at the boundaries between different structures. In regions of an image where the apparent phase gradient in a region is larger than the Nyquist sampling limit of π radians per pixel, an ambiguity is created between a positive and a negative phase gradient is created. Thus, phase unwrapping is difficult in these boundary regions. Due to this problem, the true magnitude and sign of the measured phase can be very difficult to estimate from the wrapped phase value. To reduce this problem, additional information, such as the modulation amplitude or absorption values (e.g. the absorption image A), can be used to guide phase unwrapping.

For example, due to optical effects related to the gratings used in the system, the modulation amplitude drops substantially in regions of the image where the phase gradient is large. Thus, this modulation amplitude can be used as a guide to determine regions of the image in which the phase changes at a rate greater than the Nyquist sampling limit of it radians per pixel. Examining the modulation value and surrounding phase values, this allows the exact position at which the phase gradient attains a maximum or minimum value, and an estimate of the value, and hence allows correct phase unwrapping in an edge region containing large phase gradients.

In other implementations, the absorption image A can be used. For example, where there is a boundary between different structures causing a large phase transition, there is also often an edge in the absorption image. By examining the derivative of the absorption image in the direction of the phase derivative being unwrapped, the sign of the phase gradient can be estimated, thus assisting in the phase unwrapping process.

To improve the estimation of the modulation amplitudes, an iterative procedure can be used to correct for the influence of the opposing axis modulation amplitudes in Equation 19, where separated fringes for the (j+1)th estimate are calculated using the previous estimate of the x and y modulation amplitudes, mₓ^{(j)} and m_{y}^{(j)}, thereby replacing Equations 20 and 21 with:

$${\tilde{P}}_{x}^{( j + 1 )} = \frac{exp ( {( {m}_{y}^{( j )} / 2 γ )}^{2} )}{\tilde{A} + λ} exp ( {S}_{x} \{ H ( I ) \} ) , \\ {\tilde{P}}_{y}^{j + 1} = \frac{exp ( {( {m}_{x}^{( j )} / 2 γ )}^{2} )}{\tilde{A} + λ} exp ( {S}_{x} \{ H ( I ) \} ) . \qquad [ 23 ]$$

The updated modulation amplitudes can then be calculated using the demodulation process as previously explained.

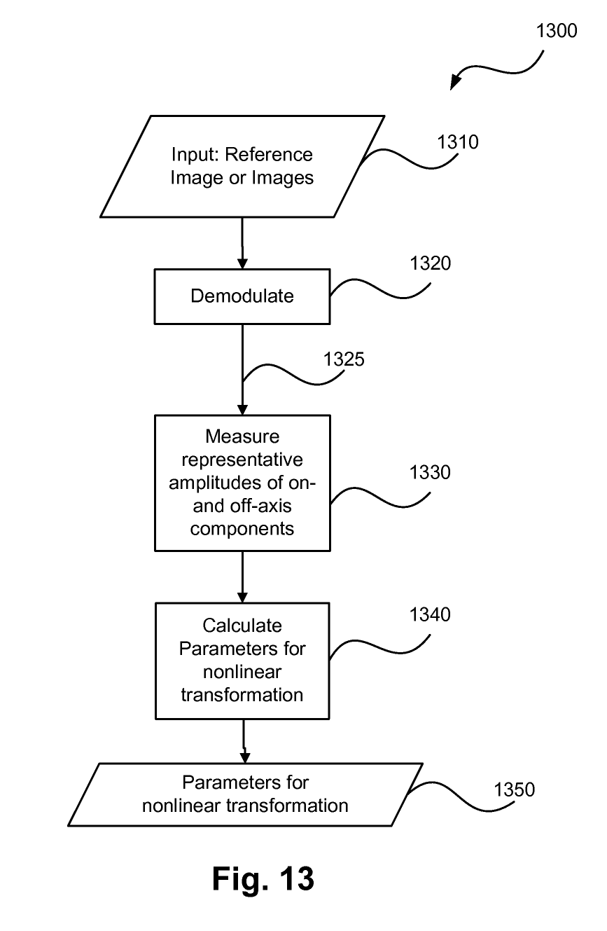

FIG. 13 shows a process 1300 for estimating parameters for the nonlinear functions used during the demodulation process. The process 1300 is preferably implemented in software stored on the HDD 1810 and executable by the processor 1805. The process 1300 operates upon one or more calibration images 1310 which are images captured using the system 100 without an object 102 present. The process 1300 initially demodulates the input images(s) 1310 in step 1320 to form a calibration demodulated image 1325. The demodulation of step 1320 may be any appropriate approach known for the purpose, including a multi-shot demodulation methods such as discussed above, to produce the reference demodulated image. In step 1330, the processor 1805 operates to measure representative amplitudes of the on-axis components and the off-axis components (i.e. the cross-terms) in the demodulated image 1325. This can be done by measuring the peaks of the image in the spectral domain. Step 1340 follows where, with the measures obtained from step 1330, the processor 1805 operates to calculate the parameters for nonlinear transformation, which form the output 1350 of the process 1300. These calculations implement for example the log-offset function of Equation 15 in terms of the amplitudes mₓ, m_{y}, mᵤ, mᵥ as discussed above with reference to Equations 13 and 14.

Turning now to FIG. 16, the input for the process 1600 is a fringe image 1610. To estimate the absorption image, the modulated carriers must be removed, which can be accomplished by a low-pass filter. To remove all of the modulated carrier frequencies completely, the low-pass filter can be implemented in the Fourier domain, where it is possible to set the amplitude of these frequencies to zero. In step 1620, a Fourier transform is applied by the processor 1805 to the image 1610 to perform the low-pass filtering. In step 1630 the Fourier transform is multiplied by a window to remove carrier frequencies. The exact width and functional form of the window used in step 1630 is not particularly important. A circular-symmetric Hanning window of width half the distance between on-axis carrier frequencies has been found by the inventors to give good results. In step 1640 an inverse Fourier transform is applied to create a low-pass filtered image in the spatial domain, which is output as the estimated absorption image 1650.

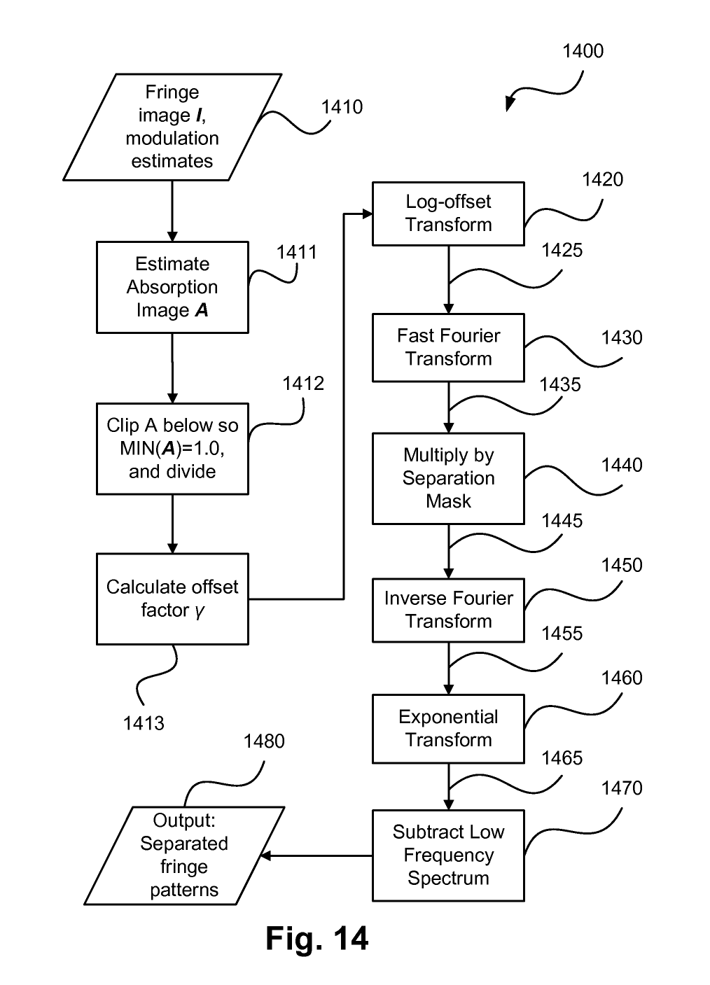

FIG. 14 shows a method 1400 by which the off-axis terms may be eliminated from the fringe image by use of the log-offset transform, thus producing a pair of separated fringe patterns. The method 1400 is a specific implementation of the process 600 described in FIG. 6.

In FIG. 14, the input 1410 to the process 1400 is a fringe image containing both on-axis and off-axis terms, along with an estimate for the parameters mₓ, m_{y}, mᵤ, and mᵥ. The units of the input image 1410 are some multiple of pixel counts from the image sensor 140, and are integer and positive or zero, with good-quality regions of the image 1410 having values greater than 100 counts. It is assumed that the pair mₓ, m_{y} have similar values, and mᵤ, mᵥ have similar values, but different from each other. These parameters can be estimated by measuring the amplitude of the signal peaks in the Fourier transform, as described previously.

In step 1411, an absorption image A is estimated for the fringe image 1410. This is preferably performed according to the method 1600 as described in FIG. 16.

The absorption image A can have pixel values ranging from 0.0 at the low end of the range (representing no detected light) to hundreds or thousands of counts at the high end of the range. In step 1412 the absorption image A is clipped so that values below 1.0 are replaced by 1.0 to avoid divide-by-zero errors during later division.

In step 1412, the fringe image I is also divided by the clipped absorption image A to produce an image with a mean value of 1.0 and modulation values as calculated, e.g. m̅ₓ=m̅_{y}=0.1; m̅ᵤ=m̅=0.03.

From these modulation values, in step 1413 an offset value is calculated,

$$γ = \frac{{m}_{x} {m}_{y}}{{m}_{u} + {m}_{v}} .$$

The offset value γ allows a log-offset transformation image 1425 of the input image 1410 to be calculated by the processor 1805 in step 1420, such that,

I←log(I+A(γ−1))

Before the log function is calculated, the argument to the log is desirably clipped to some minimum value, for example 0.01, to prevent extreme negative values resulting from the computation of the log operation.

In step 1430 the Fourier transform is calculated by the processor 1805 to transform the log-offset transformed image 1425 to the spectral domain. In the resulting spectral image 1435 the off-axis terms are substantially reduced, however harmonics are introduced to the on-axis terms by the nonlinearity of the log function.

In step 1440 the Fourier transform image 1435 is multiplied by the complex separation mask as previously described in FIG. 8 to give an image 1445. This filters out y and x terms present in the image 1425.

In step 1450, the Inverse Fourier Transform is calculated by the processor 1805 to transform the image 1445 back to the spatial domain, giving a spatial image 1455 having real and imaginary parts. The parts can be separated to be treated as separate images. Specifically, upon inverse transformation, the fringe patterns will separate into x-carrier fringes (x-phase) from the real part of the image 1445, and y-carrier fringes (y-phase) from the imaginary part of the image 1445, to be of the form

Iₓ=log(γ+mₓ cos φₓ)

and

I_{y}=log(γ+m_{y} cos φ_{y}).

In step 1460 each of these phase images is transformed by the second nonlinear function, such that

Iₓ←expIₓ=γ+mₓ cos(φₓ),

I_{y}←expI_{y}=γ+m_{y} cos(φ_{y}).

This results in two images 1465 each containing only the on-axis carriers and a constant offset term.

In step 1470 the low-frequency spectrum of each image 1465 is removed by subtracting a low-degree polynomial fit of each image, for example a 2D polynomial of degree 5, which makes the signal zero mean.

The process 1400 thereby produces an output 1480 comprising a pair of zero-mean separated fringe patterns, ready for demodulation.

The demodulation is performed as previously described in FIG. 9. For fringe patterns with a 6-pixel period, the inventors have chosen the following widths for the demodulation operation through simplex optimization. For the low-pass filter 1210, the width of the low-pass filter is 52% of the width of the Fourier transform, with a smoothing region consisting of a Hanning window extending further by 30% of the width of the low-pass filter disk. Similarly, the width of the off-axis spectrum cut filter 1220 is 3.8% of the image width, and has no smoothing region. The DC cut filter 1230 has no total-cut region, and the width of the smoothing region is 10% of the image width.

Second Specific Implementation

While the log-offset transformation can in principle eliminate cross talk due to the off-axis terms, the inventors note that there are several limitations with this approach that can limit the demodulation quality. Firstly, the log function is unbounded as normalized image values tend towards zero, so it is necessary to clip image data below before the log function is calculated. Clipping inherently introduces errors. Secondly, the modulation values of the off-axis terms are often not the same throughout the image, and thus the estimation of the modulation values typically introduces errors. Thirdly, the absorption cannot be estimated exactly. These problems can result in unwanted artefacts in demodulated images.

A more general processing scheme that does not use a logarithmic function to remove cross-terms is now considered. This processing uses two general nonlinear functions, H and G, that reduce off-axis terms of the original signal and restore the on-axis terms respectively.

A first nonlinear transform used is capable of reducing the cross-terms to a minimum value. Other desirable properties of this function are that it can accept a wide range of potential off-axis and on-axis amplitudes, that it can be invariant to a global multiplicative scaling, and that it is unambiguous to invert. While there is not a known nonlinear function which exactly cancels all off-axis terms other than the offset-log transform, it is possible to derive nonlinear functions which substantially reduce these terms.

In particular, the model case of Equation 5 can be considered and represented as,

Q(x,y)=1+a(e^{iφ}^{ₓ}+e^{-iφ}^{ₓ})+b(e^{iφ}^{_{y}}+e^{-iφ}^{_{y}})+c(e^{i(φ}^{ₓ}^{+φ}^{_{y}}⁾+e^{-i(φ}^{ₓ}^{+φ}^{_{y}}⁾)+d(e^{i(φ}^{ₓ}^{+φ}^{_{y}}⁾+e^{-i(φ}^{ₓ}^{+φ}^{_{y}}⁾)

A general non-linear function h(v) specified by a finite polynomial series analytic at v=1 is given by:

$$h ( v ) = {\sum }_{j = 0}^{N} {{h}_{j} ( v - 1 )}^{j} \qquad [ 25 ]$$

where the coefficients hⱼ specify the function completely.

By expanding h(v) about v=1 the following expansion in the harmonics of the phase images Φₓ and Φ_{y} is obtained:

$$\begin{matrix}h ( v ) = {\sum }_{j = 0}^{N} {{h}_{j} [ Q ( x , y ) - 1 ]}^{j} \\ = {\sum }_{k = - N}^{N} {\sum }_{l = - N}^{N} {C}_{k , l} {e}^{i k {Φ}_{x}} {e}^{i l {Φ}_{y}}\end{matrix} \qquad [ 26 ]$$

where C_{k,l} is the element of the cross-coefficient matrix C at the position (k,l). In this case the terms of an infinite power expansion cannot be solved iteratively as all coefficients in the series expansion of Equation 6 are involved in each term of the coefficient matrix. Note that due to the fact that Q(x,y) is real, the matrix has the symmetry, C_{k,l}=C_{-k,-l}.

The problem of minimizing the cross terms for a general nonlinear function can now be considered. Considering the fundamental off-axis terms at Φₓ+Φ_{y} and Φₓ−Φ_{y}, it is desirable to minimize Rₒₐ which measures the power in these off-axis terms, measured by the squared magnitude of the amplitudes C_{1,1}² and C_{-1,1}², relative to the power in both on-axis terms, measured by the squared magnitude of the amplitudes C_{0,1}² and C_{1,0}². Such measure is given by:

$${R}_{oa} = \frac{{C}_{1 , 1}^{2} + {C}_{1 , - 1}^{2}}{{C}_{0 , 1}^{2}} + \frac{{C}_{1 , 1}^{2} + {C}_{1 , - 1}^{2}}{{C}_{1 , 0}^{2}} \qquad [ 27 ]$$

Seeking the parameters of the nonlinear function hₖ that minimize the power ratio of Equation 27 gives a potential nonlinear function to use for off-axis term suppression. Alternatively, a function that minimizes higher order off-axis terms may be suitable,

$${R}_{oa} = ( \frac{1}{{C}_{0 , 1}^{2}} + \frac{1}{{C}_{0 , 1}^{2}} ) {\sum }_{m = 1}^{M} {\sum }_{n = 1}^{M} ( {C}_{m , n}^{2} + {C}_{m , - n}^{2} ) \qquad [ 28 ]$$

For example, considering the simplest case of a second order nonlinear function, N=2, it is possible to find the minimum of Equation 27 as a function of the parameters h₁ and h₂ and arbitrarily set the constant h₀=0. To simplify presentation, assume a=b and then find that

$${h}_{2} = - \frac{{h}_{1} ( - {a}^{2} c - {a}^{2} d + {c}^{3} + {c}^{2} d + {cd}^{2} + {d}^{3} )}{2 {a}^{2} ( - 2 {a}^{2} + {c}^{2} + 2 cd + {d}^{2} )} \qquad [ 29 ]$$

When c=d it is possible to exactly cancel the cross term with h₂=−ch₁/(2 a²). Considering a cubic function, it is possible to exactly set the first off-axis harmonics to zero. However, where this is done the higher order off-axis terms will be larger than the quadratic nonlinear function. It may therefore be preferable to reduce the total off-axis power using Equation 28. Additionally the analysis can be extended to higher orders than cubic and progressively reduce the cross-terms to optimal levels.

The preceding analysis allows construction of a forward transform for the reduction of off-axis cross-terms. To construct the second backward transform it is possible to either directly invert the first transform or alternatively to construct a function that is separately optimized for a different metric relating to image quality. As an example, the calculation of the backwards transform can be derived as the inverse of the on-axis terms alone. Note that in both cases the backward function g(v) may not be equal to the inverse of the forward function h(x).

The backward function g(v) of the x on-axis terms can be calculated as a formal power series defined by:

$$g ( v ) = {\sum }_{m = 0}^{∞} {g}_{m} {v}^{m} \qquad [ 30 ]$$

where the coefficients gₘ can be calculated from the on-axis coefficients C_{m,0} and C_{0,m} respectively using an iterative algorithm, of which there are many well-known such algorithms. The function to restore the y on-axis terms can be derived similarly.

In the case of the quadratic transform, the inverse nonlinear function can be directly computed in this instance as,

$$g ( v ) = \frac{1}{2 {h}_{2}} ( \pm \sqrt{4 {h}_{2} v + 1} - 1 ) \qquad [ 31 ]$$

However, this quadratic function has a number of disadvantages. The inverse function requires that h₂ be small enough so that the branch of the square root function can be correctly determined. This required the parameters of the original model, specifically the on-axis and off-axis powers, to be monitored to ensure that they do not go outside the limits required by the model.

A more desirable function would possess the properties that it can accept a wide range of potential off-axis and on-axis amplitudes, that it can be invariant to a global multiplicative scaling, and that it is unambiguous to invert. For these reasons consideration of other classes of nonlinear functions with these properties is appropriate. One example is a power function

h(Q)=Q^{α} [32]

where α is a non-integer. A good inverse function to use is

g(h)=h^{β} [33]

where β may be different from 1/α.

The parameter α of the first nonlinear transform is determined prior to using the function on a real image. After processing with the first nonlinear function, the on-axis terms are filtered using the filters in the Fourier domain, as described previously for the log-offset transform.

While the first nonlinear transform reduces the off-axis terms, it introduces harmonics to the on-axis terms. Therefore, an aim of the second nonlinear function is to reduce these harmonics so that the image can be demodulated with minimal artefacts. The parameter β of the second nonlinear transform is again determined prior to the actual demodulation, based on minimize the reconstruction error of the process. Finally, the images are filtered and demodulated.

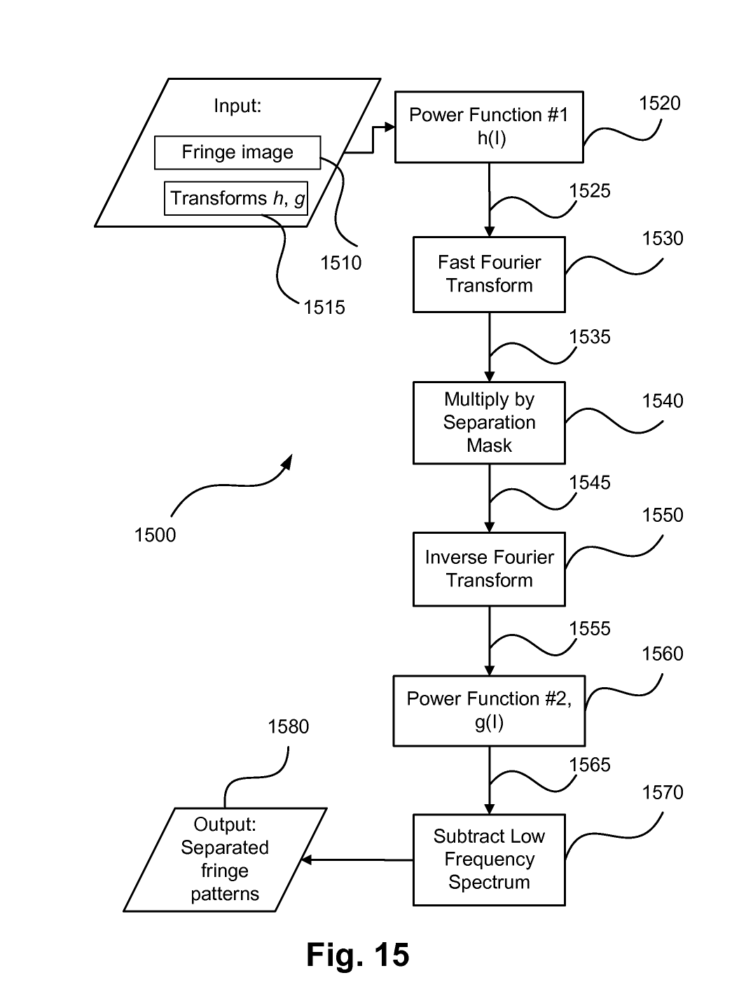

The use of two general nonlinear functions, h and g, that reduce off-axis terms of the original signal and minimize the RMS reconstruction error, to demodulate a received fringe pattern is shown in FIG. 15 and represents an exemplary implementation of the process 600 described in FIG. 6.

FIG. 15 shows a flowchart of a method 1500 for demodulating a fringe pattern that is preferably implemented in software, stored on the HDD 1810 and executable by the processor 1805. The input to the method 1500 is a fringe image 1510 and two parameterized non-linear transforms 1515, a first transform h and a second transform g. The units of the image 1510 are some multiple of photon counts from the image sensor 140, and are integer and positive or zero, with image quality generally increasing with photon count and good-quality regions of the image having values greater than 100 counts. The transforms 1515 are typically sourced from predetermined transforms stored in the HDD 1810. The image 1510 may be directly captured from the sensor 140 or retrieved from storage in the HDD 1810 or via the network 1820.

In step 1520 the first nonlinear power transform is applied to the input image 1510, where the application of a nonlinear transform (h) to an image is shown in FIG. 5 for a nonlinear function ƒ=h given in Equation 32. The parameter α of this first nonlinear transform have been determined using an optimization process that determines the parameters that minimizes the off-axis terms and/or the errors between the reference and demodulated image, as shown in FIG. 11. Step 1520 results in a first transformed image 1525.

In step 1530 the discrete (Fast) Fourier transform of the image 1525 is calculated by the processor 1805, forming a spectral image 1535. In the spectral image 1535 the off-axis terms are substantially reduced, however harmonics are introduced to the on-axis terms by the nonlinearity of the first nonlinear function.

In step 1540, the Fourier transformed image 1535 is multiplied by the complex separation mask as previously described in FIGS. 8A and 8B, to give a masked complex image 1545.

In step 1550 the processor 1805 calculates an Inverse Fourier Transform to transform the masked image 1545 back to the spatial domain to form an image 1555 in which the fringe patterns are, as in step 1450, separated into x-carrier fringes in the real part of the image, and y-carrier fringes in the imaginary part of the image.

In step 1560 each of the separated images, being parts of the image 1555 is transformed by the second nonlinear power function (g), where the application of a nonlinear transform to an image is shown in FIG. 5 for a nonlinear function ƒ=g given in Equation 33. The parameters β of this second nonlinear transform have been determined previously using an optimization process that determines that minimizes the errors between the reference and demodulated image, as shown in FIG. 11. Step 1560 operates to remove harmonics from the images.

In step 1570 the low-frequency spectrum is removed from the image 1555 by subtracting a low-degree polynomial fit of each part image, for example a 2D polynomial of degree 5, which makes the signal zero mean.

The output of the method 1500 is a pair of zero-mean separated fringe patterns 1580 ready for demodulation.

The demodulation is preferably performed as previously described in FIG. 9. For fringe patterns with a 6-pixel period, we have chosen the following widths for the demodulation operation through simplex optimization. For the low-pass filter 1210, the width of the low-pass filter is 52% of the width of the Fourier transform, with a smoothing region consisting of a Hanning window extending further by 30% of the width of the low-pass filter disk. Similarly, the width of the off-axis spectrum cut filter 1220 is 3.8% of the image width, and has no smoothing region. The DC cut filter 1230 has no total-cut region, and the width of the smoothing region is 10% of the image width.

The two nonlinear functions take parameters that have been optimized previously. FIG. 11 shows this optimization process, and has been described previously. In this second specific implementation the parameters that are required to be estimated for the nonlinear functions are a for the first nonlinear function and β for the second nonlinear function. The two parameters are chosen to minimize the mean squared error (MSE), or other error measure, between the candidate demodulated image 1150 and the reference demodulated image 1130.

### INDUSTRIAL APPLICABILITY

The arrangements described are applicable to the computer and data processing industries and particularly for the demodulation of fringe images to obtain details from biological and other structures.

The foregoing describes only some embodiments of the present invention, and modifications and/or changes can be made thereto without departing from the scope and spirit of the invention, the embodiments being illustrative and not restrictive.

We claim:

1. A method of demodulating an image captured from an imaging system having at least one two-dimensional grating, the captured image comprising a phase modulated fringe pattern comprising cross-term phase components resulting from presence of the at least one two-dimensional grating, the method comprising:
determining parameters of at least a first non-linear transformation for attenuating the cross-term phase components, wherein the parameters of the first non-linear transformation are determined for the imaging system to reduce artefacts in a demodulated image introduced by the cross-term phase components; and
demodulating the captured image by applying at least the first non-linear transformation with the determined parameters to the captured image to attenuate the cross-term phase components.

2. A method according to claim 1, wherein the determining parameters of the first non-linear transformation comprises:
determining a ratio between a magnitude of the cross-term and a magnitude of on-axis phase components for a calibration image captured using the imaging system; and
determining parameters of the non-linear transformations using the determined ratio.

3. A method according to claim 1, wherein the determining parameters further comprises:
establishing a parameterised non-linear transformation to reduce impact of the cross-term phase components for further demodulation;
receiving a plurality of reference images captured with the imaging system of a phase modulated fringe pattern comprising cross-term phase components;
first demodulating the reference images using a multi-shot demodulation method to produce a reference demodulated image;
identifying initial parameters for the established parameterised non-linear transformation to form an initial non-linear transformation;
forming a candidate demodulated image by second demodulating one of the reference images using a single-shot demodulation method applied to the reference image transformed in accordance with the initial non-linear transformation; and
comparing the candidate demodulated image with the reference demodulated image to adjust parameters of the non-linear transformation.

4. A method according to claim 3 further comprising repeating the second demodulating with the adjusted parameters to form a revised candidate demodulated image to reduce an error between the candidate demodulated image and the reference demodulated image.

5. A method according to claim 4, wherein the second demodulating is repeated until the error falls below a predetermined limit.

6. A method according to claim 3, wherein the adjusted parameters are utilised to reduce impact of cross-term phase components in demodulation of further images captured by the imaging system.

7. A method according to claim 1, wherein demodulating the captured image further comprises:
applying the first non-linear transformation to the captured image to produce a first image with attenuated the cross-term phase components; and
producing an x-phase image and a y-phase image by filtering from the first image, in Fourier domain, y and x terms of the first image respectively.

8. A method according to claim 7, further comprising:
establishing a second non-linear transformation configured for attenuating harmonics introduced by application of the first non-linear transformation to the captured image, wherein the second non-linear transformation is established by inverting the first non-linear transformation; and
applying the second non-linear transformation to each of the x-phase image and the y-phase image to attenuate harmonics introduced by operation of the first non-linear transform.

9. A method according to claim 7, wherein the filtering comprises:
transforming the first image into the Fourier domain;
applying at least one mask to the transformed first image; and
transforming the masked image into the spatial domain.

10. A method according to claim 9, wherein the applying comprises multiplying the transformed first image by a first mask to produce the x-phase image and by a second mask to produce the y-phase image.

11. A method according to claim 10, wherein the at least one mask is adapted to remove predetermined frequency spectra from the image.

12. A method according to claim 8, further comprising subtracting a low frequency spectrum from the phase images to for separated fringe patterns.

13. A method according to claim 1, wherein the first non-linear transformation comprises an offset-logarithmic function.

14. A method according to claim 13, wherein the second non-linear transformation comprises an exponential transform.

15. A method according to claim 8, wherein the first and second non-linear transformations comprise respective power functions.

16. A method according to claim 1, wherein the imaging system comprises an X-ray interferometer system.

17. A non-transitory computer readable storage medium having a program recorded thereon, the program being executable by computer apparatus to demodulate an image captured from an imaging system having at least one two-dimensional grating, the captured image comprising a phase modulated fringe pattern comprising cross-term phase components resulting from presence of the at least one two-dimensional grating, the program comprising:
code for determining parameters of at least a first non-linear transformation for attenuating the cross-term phase components, wherein the parameters of the first non-linear transformation are determined for the imaging system to reduce artefacts in a demodulated image introduced by the cross-term phase components; and
code for demodulating the captured image by applying at least the first non-linear transformation with the determined parameters to the captured image to attenuate the cross-term phase components.

18. A non-transitory computer readable storage medium according to claim 17 wherein the code for determining parameters of the first non-linear transformation comprises:
code for determining a ratio between a magnitude of the cross-term and a magnitude of on-axis phase components for a calibration image captured using the imaging system; and
code for determining parameters of the non-linear transformations using the determined ratio;
code for establishing a parameterised non-linear transformation to reduce impact of the cross-term phase components for further demodulation;
code for receiving a plurality of reference images captured with the imaging system of a phase modulated fringe pattern comprising cross-term phase components;
code for first demodulating the reference images using a multi-shot demodulation method to produce a reference demodulated image;
code for identifying initial parameters for the established parameterised non-linear transformation to form an initial non-linear transformation;
code for forming a candidate demodulated image by second demodulating one of the reference images using a single-shot demodulation method applied to the reference image transformed in accordance with the initial non-linear transformation; and
code for comparing the candidate demodulated image with the reference demodulated image to adjust parameters of the non-linear transformation.

19. A non-transitory computer readable storage medium according to claim 17 wherein code for demodulating the captured image further comprises:
code for applying the first non-linear transformation to the captured image to produce a first image with attenuated the cross-term phase components;
code for producing an x-phase image and a y-phase image by filtering from the first image, in Fourier domain, y and x terms of the first image respectively;
code for establishing a second non-linear transformation configured for attenuating harmonics introduced by application of the first non-linear transformation to the captured image, wherein the second non-linear transformation is established by inverting the first non-linear transformation; and
code for applying the second non-linear transformation to each of the x-phase image and the y-phase image to attenuate harmonics introduced by operation of the first non-linear transform.

20. An imaging system comprising:
X-ray Talbot imaging apparatus having at least one two-dimensional grating and configured to capture an image comprising a phase modulated fringe pattern comprising cross-term phase components resulting from presence of the at least one two-dimensional grating;
a computer processor apparatus coupled to the imaging apparatus, the computer apparatus comprising at least a processor and a memory coupled to the processor, the memory having a program recorded thereon and executable by the processor to demodulate the image, the program comprising:
code for determining parameters of at least a first non-linear transformation for attenuating the cross-term phase components, wherein the parameters of the first non-linear transformation are determined for the imaging system to reduce artefacts in a demodulated image introduced by the cross-term phase components; and
code for demodulating the captured image by applying at least the first non-linear transformation with the determined parameters to the captured image to attenuate the cross-term phase components.
